(19) United States
(12) Patent Application Publication
(10) Pub. No.: US 2016/0203146 A1
(43) Pub. Date: Jul. 14, 2016

(54) Ecosystem Services Index, Exchange and Marketplace and Methods of Using Same

(71) Applicants: Gary Allison Moll, Owings, MD (US); Charles Mondello, Irmo, SC (US); Michael Flaxman, San Francisco, CA (US)

(72) Inventors: Gary Allison Moll, Owings, MD (US); Charles Mondello, Irmo, SC (US); Michael Flaxman, San Francisco, CA (US)

(21) Appl. No.: 14/594,671

(22) Filed: Jan. 12, 2015

(51) Int. Cl. G06F 17/30; G06Q 50/26

(52) U.S. Cl. CPC G06F 17/3087; G06F 17/30321; G06F 17/30241; G06F 17/3053; G06F 17/30997; G06F 17/30525; G06Q 50/26

(57) ABSTRACT

A method of calculating an ecosystem services index score, comprising: receiving area of interest information from a user of an ecosystem services index calculating system; assigning an ecoaddress to the area of interest by a processor of the system; retrieving ecosystem services information about the area of interest from at least one database; retrieving ecosystem services information about the area of interest on at least one scale size larger or smaller than the area of interest from at least one database; and, deriving a multi-scale ecosystem services index score blending the retrieved ecosystem services information about the area of interest.

### FIELD AND BACKGROUND OF THE INVENTION

The present invention, in some embodiments thereof, relates to ecosystem services and more particularly, but not exclusively, to an environmental performance index and uses of the same.

Throughout most of its initial 40 years of history, geographic information system (“GIS”) technology was relatively expensive and required very significant technical expertise to operate. Typical systems required specialized hardware for map digitizing, and specialized workstations costing tens of thousands of dollars each. Setting up these systems required substantial technical and scientific background, typically the equivalent of a Master's degree. Given these requirements, it is perhaps not surprising that uses became highly specialized and highly professionalized. Essentially, each scientific discipline and each governmental department or program began to use geographic information technology separately and incrementally. Foresters used GIS for stand inventories and projections of future timber conditions, hydrologists used GIS as both input and output to their hydrological models, and ecologists used GIS to quantify habitat.

This led to strong technical advances in each field, but also to professional and social fragmentation of knowledge. In the 1980s, this combination led to substantial criticism of the field, and development of a significant community of practice around the concept of “public participation GIS.” The idea was that GIS had become dominated by a technical “priesthood” that it was inaccessible to common people, and democratically unaccountable. This view of GIS persisted for a couple of decades, and only started to shift with the advent of interne-based GIS, and of consumer geovisualization tools in the late 1990's and early 2000s.

In the 1990s and 2000s, a new set of ideas about environmental protection began to be developed. These refocused attention on the value of maintaining and restoring particular ecological systems for the direct human benefits which they provide. These so-called “ecosystem services” could be quantified using GIS software. They included direct tangible services such as flood protection and air pollution reduction, as well as indirect benefits such as existence-value for rare species. Rather than to focus on the environmental consequences of specific large projects, these approaches sought to quantify the costs and benefits of maintaining “green infrastructure.” They also quantified the often very-large costs of conventional “gray infrastructure” (in example but not limited to man-made roads, sidewalks, building) solutions.

A noteworthy contribution in this area was the GIS plug-in software package known as “CITYgreen” released in 1996. This application was created by the nonprofit organization American Forests and one of the co-inventors named in this patent application (Moll). CITYgreen. It was the first and only commercially-available software package quantifying green infrastructure for at least a decade. This software was developed to provide community leaders with high quality technical assessments of the value and potential of their green infrastructure. The software gave local communities the ability to conduct scientific and engineering grade assessments of the landscape under their authority using the desktop GIS software in common use by the communities.

A second new concept of importance to this field was the notion of “geodesign.” As defined by another of the co-inventors named in this patent application (Flaxman), geodesign is the combination of geographic design tools with integrated impact assessment methods which consider spatial context. A specific example implementation known as “ArcSketch” was created by Flaxman and colleagues at ESRI and released publically in 2006. Working within a desktop GIS environment, this software combines three traditionally-separate steps in GIS workflows so as to facilitate rapid interactive design evaluation. Rather than to separately specify geometry, its spatial attributes and its cartography as in conventional GIS editing, the ArcSketch tool uses an example-based method. The user picks an example of a desired “type” of object from a legend, and can immediately create new features of that type which clone its attributes and cartography.

However despite advances in the field, the current state of environmental planning and design tools has left several major gaps which function as conceptual and practical barriers in the field and/or related fields.

Previous attempts have been made to make GIS technology more efficient, more usable and/or more functional.

U.S. Pub. No. 2005/0137921 to Shahriari, the disclosure of which is incorporated herein by reference, describes a method for evaluating environmentally-friendly construction projects according to a multiple certification levels to determine which certification level is cost effective for the environmentally-sound construction project. The method establishes a construction rating system used in analyzing the construction project and having multiple certification levels corresponding to a number of credits that may be earned with specific improvements. Using a central processing unit having a database with the various credits, the user will select the particular credits corresponding with the construction improvements to be implemented in the construction project. The costs and benefits of the project, both initially and during the life of the project, will be calculated using interest values entered by the user or stored in the database. The costs and benefits of the construction project will then be compared over the lifetime of the project for the user to select the construction improvements meeting the desired certification levels.

U.S. Pub. No. 2010/0223081 to Espino, the disclosure of which is incorporated herein by reference, describes an energy audit and sustainability analysis business model, comprising an equipment/appliances/materials database, a member/audits/sales member customer database, a certification Leadership in Energy and Environmental Design/Energy Star consulting services/construction services database, a programming computer, and an auditing system computer software that produces a report. The energy audit and sustainability analysis business model allows comparisons of a non-green building structure to a potential green building structure. The auditing system allows for data in three areas to be analyzed to give a real comprehensive view of overall saving, sustainability, and individual reductions in environmental footprints.

U.S. Pub. No. 2009/0119023 to Zimmer, et al., the disclosure of which is incorporated herein by reference, describes a product ecological and/or environmental rating system and method for ecologically and/or environmentally conscious consumers and/or product manufacturers for “grading” the ecological and/or environmental character of products and/or their manufacturing methods. This grading may include one or more of: determining a type or amount of toxic material used in making the product and assigning a toxic consumption value for the product; determining a type or amount of waste created in making the product and assigning a waste production value for the product; determining a type or amount of environmentally preferred materials used in making the product and assigning a material value for the product; and determining an extent to which the product or its manufacturing methods provide an ecological or environmental advance over existing products or manufacturing methods and assigning an advancement value for the product. The final product grade then may be determined based on the assigned value or values.

International Pat. App. No. WO2009111800 to Lopez, et al., the disclosure of which is incorporated herein by reference, describes a system and method for quantifying, aggregating and bundling green incentives based on green features enables applying at least a portion of the credits/incentives to financial transactions. Quantification includes estimating and/or monitoring usage of utilities, comparing the usage to a predetermined baseline value, and valuating an effectual energy savings that includes actual savings plus incentive values. Quantification relies on a database, which may include credits, deductions, and other green incentives data that contribute to the effectual savings. The effectual savings may be applied to early repayment of a mortgage loan, improved terms for the loan, investment in securities, and/or other trading. The method standardizes values of green incentives in energy units and/or monetary units. The method aids in qualifying the building projects based on a concrete estimation of the effectual energy savings. The method forms a bridge between green or sustainable/renewable technologies and the financial institutions and markets.

The EPA EnviroAtlas consists of a large digital library including a spatial data library which allows users to research published information on a wide variety of topics and build maps using spatial data for analysis using desktop GIS. The EnviroAtlas does not require environmental analysis to be conducted by environmental units and, in fact, shows users how to conduct an analysis using political boundaries rather than environmental units in their on-line examples. Also, the EnviroAtlas provides analysis tools that require the users to have additional GIS software.

### SUMMARY OF THE INVENTION

There is provided in accordance with an exemplary embodiment of the invention, a method of calculating an ecosystem services index score, comprising: receiving area of interest information from a user of an ecosystem services index calculating system; assigning an ecoaddress to the area of interest by a processor of the system; retrieving ecosystem services information about the area of interest from at least one database; retrieving ecosystem services information about the area of interest on at least one scale size larger or smaller than the area of interest from at least one database; and, deriving a multi-scale ecosystem services index score blending the retrieved ecosystem services information about the area of interest.

In an embodiment of the invention, ecosystem services information includes at least one of soil metrics, geology, terrain, water metrics, air metrics, nature of land usage, wildlife, human demographics, financial, geography (such as, but not limited to, parcel, road, address and boundary data), manmade objects and consumables, forest, grasslands, agriculture, farming, wildlife, natural resources, carbon generation, water usage, weather, and energy consumption.

In an embodiment of the invention, scale is represented by Hydraulic Unit Code, but can optionally utilize other metrics of scale, such as defined by national, local or regional scales, by geopositional accuracy, or as a function of the resolution of the data set in terms attribute size versus actual. As an example this is ground sample distance the size of a pixel on grounds

at least one of national, local or regional scale, a scale defined by geopositional accuracy, a scale as a function of the resolution of the data set or Hydraulic Unit Code.

In an embodiment of the invention, the ecosystem services index score is derived based on a zoom level of the user on a digital map.

In an embodiment of the invention, the score is recalculated as the user changes the zoom level on the map.

In an embodiment of the invention, the score is automatically recalculated as the user manually shifts area of interest.

In an embodiment of the invention, at least one of the receiving, assigning, retrieving and deriving is performed at a remote location relative to the user.

In an embodiment of the invention, the method further comprises comparing the ecosystem service index score of the area of interest with an ecosystems service index score of a second area.

In an embodiment of the invention, the second area is an area that is similar in some aspect to the area of interest.

In an embodiment of the invention, the method further comprises searching at least one database for additional areas similar in some aspect to the area of interest but with a higher ecosystem service index score.

In an embodiment of the invention, the method further comprises presenting to the user a list comprising at least one of the additional areas and the management practices associated with the at least one additional area.

In an embodiment of the invention, the method further comprises creating a challenge to at least one user to encourage the adoption of at least one presented management practice.

In an embodiment of the invention, the method further comprises sharing the challenge on at least one social media platform to involve additional users.

In an embodiment of the invention, the method further comprises awarding credits to the at least one user for adopting at least one presented management practice.

There is further provided in accordance with an exemplary embodiment of the invention, a method of providing an ecosystem services index marketplace, comprising: creating a universal ecosystem services index capable of placing a value on ecosystem services; assigning an ecosystem services index score to at least one service or holding; and, facilitating the transfer of the at least one service or holding, where the ecosystem services index score is the measure of value for conducting the transfer of the at least one service or holding.

In an embodiment of the invention, a holding is at least one of a service, property, item and product.

In an embodiment of the invention, facilitating is through at least one of auction, selling, buying, trading, and exchanging.

There is further provided in accordance with an exemplary embodiment of the invention, a system for calculating an ecosystem services index score, comprising: at least one user interface device configured to receive input from a user and display system output; at least one database with ecosystem services information stored thereon; at least one processor configured to derive at least one ecosystem services index score based on received user input from the at least one user interface device and ecosystem services information retrieved from the at least one database.

In an embodiment of the invention, at least one of the at least one database and at least one processor are located remotely from the user.

In an embodiment of the invention, the user interface device is at least one of a computer, a phone, a tablet and terminal.

In an embodiment of the invention, the at least one database is a database accessible via a global communications network.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1 is a flowchart of the general process for calculating an Ecosystem Services Index, in accordance with an exemplary embodiment of the invention;

FIG. 2 is a schematic showing a hierarchy and inputs for analyzing an ecosystem, in accordance with an exemplary embodiment of the invention;

FIG. 3 is a schematic showing inputs for calculating a representative ecosystem services value, in accordance with an exemplary embodiment of the invention;

FIG. 4 is a user experience flowchart, in accordance with an exemplary embodiment of the invention;

FIG. 5 is a flowchart of the general process for determining what ecosystem services are possible, in accordance with an exemplary embodiment of the invention;

FIG. 6 is a schematic example of a multi-scale environmental index calculation; in accordance with an exemplary embodiment of the invention; FIG. 7 is an example of a practical application of the ESI and/or for providing product recommendation, in accordance with an exemplary embodiment of the invention;

FIG. 8 is an example of applying the ESI to real estate transactions and/or public policy formation, in an exemplary embodiment of the invention;

FIG. 9 is a summary of the roll up of sample data layers to a basic Ecosystems Services Index Marketplace analysis, in accordance with an exemplary embodiment of the invention;

FIG. 10 is a map of Durham, NC as viewed by the ESI system, in accordance with an exemplary embodiment of the invention; and,

FIG. 11 is a graphic process diagram of a practical application of the ESI system and methods for recommending best management practices to a user, in accordance with an exemplary embodiment of the invention.

### DESCRIPTION OF SPECIFIC EMBODIMENTS OF THE INVENTION

The present invention, in some embodiments thereof, relates to ecosystem services and, more particularly, but not exclusively, to an environmental performance index and uses of the same.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Generally

In an embodiment of the invention, systems and methods are provided for simplifying a user interface and/or providing more comprehensive analysis options than what was previously available in the ecosystem services industry. For example, analysis includes residential development and/or agricultural activities (in addition to large projects) and/or optionally blends point source bases and non-point source bases. In some embodiments of the invention, a universal environmental performance index is calculated for and/or provided to user of the system. In an embodiment of the invention, “ecosystem services” are services provided by nature (or by engineered green infrastructure) which are valued by human beings. These can include immediate and/or practical services such as storm-water management, flood control and/or pollination reduction, as well as more abstract services such as the “persistence value” of endangered species or even the aesthetic value of ocean and mountain views.

In an embodiment of the invention, the Environmental Services Index (“ESI”), and its related Ecosystem Services Index Marketplace (“ESIM”), takes complex scale-varied content and blends it with a live environment for a simple, optionally multi-scaled and/or informative user interactive experience. Through a rollup of complex geospatial data, information is viewed and mashed despite varied scale and type. This enables users not trained in geospatial design and systems to be provided with simple to use guidance based on air, soil, water, and/or human terrain content. Users are often faced with complex decisions from big data. For example, in a house purchasing scenario, disparate data from sources such as census, real-estate, crime, weather and/or education are all required to make an informed decision. While environmental metrics already exist they are too often focused within political boundaries and do not address the problem at the ecological system level. The combination of incorrect data scales, types and boundaries, in conjunction with untailored guidance results in the extraction of erroneous direction and conclusions. The ESI and ESIM work to provide accurate, understandable information for good decision making, actionable data. This collaborative analysis is presented as a customized dashboard experience.

Urban environmental issues are complicated socially and culturally, as well as biophysically. Addressing these three challenges requires a communications and engagement strategy which operates at both individual and institutional levels.

The population at large currently has very few mechanisms to understand the environmental impacts of their individual actions, and this can lead to a sense of complacency or futility. One person cannot do much to address global warming, so why do anything?

Government and other organized institutions have somewhat more influence, but cannot move without grassroots support, and are often paralyzed by lack of clear assessment of where they stand, which pathways forward are available and which goals are achievable. Most government staff and most of the engineering and building trades have been trained in ways which consider only gray infrastructure, and often emphasize single-use optimization. Making effective use of green infrastructure is outside of the comfort zone of most current practitioners. One of the most important sets of techniques available to both individuals and institutions is the combination of continuous assessment and of scenario planning. The idea behind continuous assessment is simple: if you measure what is important, and do so regularly, you are in good position to measure progress toward goals. You will also know immediately when your actions are ineffective. Scenario planning is being able to ask “what if?” before committing to a course of action. Said another way, it is far better and cheaper to make mistakes in the modeling world than in the real one. Combining these two concepts in a way which engages with and communicates to individuals and institutions is at the core of our proposal for improving green infrastructure.

At the individual level, people will be able to connect what they do personally with environmental consequences, generating an “environmental report card” at the household level. This simple high-level assessment is coupled with incentivized and custom-tailored recommendations, allowing an individual to interactively weigh the consequences of these alternatives.

At the organized or institutional level, a similar “environmental report card” based on group-level measures and integration of individual activities is provided in some embodiments of the invention. For simplicity and consistency, the institutional level uses identical measures and indicators to the parcel-level (individual level) system, but run at broader spatial scales, in an embodiment of the invention. Institution-scale geographic data is much more widely available than parcel-scale information. In some embodiments of the invention, most report card measures will be derived from analyses of nationally-available data sets as modified by local contributions

At this scale, it is possible to assess existing green and gray infrastructure, and make recommendations based on geographic information systems analyses of existing and potential ecosystem services. Two types of alternatives and their consequences could also be reviewed and discussed. The first would be group projects occurring on public lands. The second would be projects based on the aggregation of individual member's activities scaled to the group level.

The final type of data is parcel level sketch-mapping of existing gray and green infrastructure. This will be supported by a geo-sketching interface which allows users to rapidly digitize classified maps atop aerial imagery. Users will be able to measure their detailed environmental data themselves, and optionally to contribute it for research use. Each measure will be constructed as an independent spatial web service, using international geographic data services standards and available for re-use for alternative purposes.

In an embodiment of the invention, the systems and methods are configured to provide enhance user access, evaluation, exploration and/or social tools.

For example with respect to access, the system: can be accessed, integrated, visualized and analyzed using computing systems, Internet terminals, tablets, smart phones, and common internet web browsers; can be downloaded from the Internet and used off line, then optionally, automatically re-linked/synchronized to an online system; automatically filters and clips data delivered based on requesting device capabilities, network bandwidth, and user interest; and/or, allows individuals, businesses, community organizations and government to access a (standardized) common geospatial information base, provided in a format which requires no specialized software to view or manipulate. “Geospatial” data encompasses data which may have a tag with a coordinates representing a location either relative or absolute to a location in two or three dimensional space.

For example with respect to evaluation, the system: provides high-level metrics and consistent symbology, allowing individuals, institutions, businesses or agencies to understand environmental performance across spatial scales and/or topics; provides individuals, institutions, businesses and/or agencies a simple, universal metric for understanding the condition of their environment regardless of mapping scale; provides individuals and groups the ability to analyze their current environmental infrastructure, and evaluate opportunities to improve it; employs web services for remote sensing and geographic information systems to discover new information, access existing data depositories, connect disparate data, conduct complex data analyses and summarize the findings into simple to understandable quantitative results; provides the ability to produce real time summaries of the ESI (described in more detail below) for common or customized geospatial boundaries, where the boundaries are predetermined and hierarchical, such as national, state, county and municipal boundaries, and where appropriate summaries are displayed based on current map scale and extent, and furthermore, where summaries of the current geographic window extent or taxonomic categories are optionally computed dynamically; provides all tiers of users with the ability to evaluate their environmental performance; and/or, enables historical green infrastructure fusion, analysis, and/or assessment.

For example with respect to exploration, the system: provides a single platform and interface to environmental data which prior to the ESI requires dozens of interfaces to access, for example providing access to both point and non-point information (polygon) within integrated views; provides dynamic synthesis capabilities traditionally requiring custom GIS analysis, for example, supporting summarization and visualization of any environmental value within any political or ecological geography.

For example with respect to social, the system: provides the ability for individuals and/or groups to elect to share their environmental index through social media, including initial conditions and/or progress towards goals expressed as “challenges”; provides the ability to compute indices based on geospatial-enabled social media, for example to dynamically summarize “tweets” with particular characteristics, as well as general analysis that supports the initiation and tracking of user-defined environmental index social media campaigns; and/or supports user-defined groups, so that the actions of individuals, business, community organizations and/or government can be benchmarked and/or progress towards both individual and/or group goals can be tracked with a common or universal mechanism.

In an embodiment of the invention, systems and methods of use are provided for synthesizing government, private party and/or volunteered geographic data to generate an interactive spatial report card of environmental performance. Optionally, at least a portion of the system is online, for example at least some of the data gathering and/or processing, the customer and/or client interface, and/or report generating and/or delivery. In an embodiment of the invention, the system is configured to use sensor fusion and/or analytic techniques which previously required desktop geographic information systems and advanced training in several disciplines.

In an embodiment of the invention, the system generates an Ecosystem Services Index (“ESI”, as used herein) (described in more detail in the ESI Section, below) which provides a mechanism for creating and/or sharing spatial environmental indices and/or related participatory social challenges (described in more detail in the Challenges Section, below). The ESI is designed to capture, aggregate, report, and/or guide all aspects of society on their individual and collective effects on the environment. The index is a method, tool set and visualization set to foster all levels of collaboration with the goal of environmentalist growth to all components of society.

The basic index is constructed using a scalable internet-based mechanism which builds upon international and/or national spatial data infrastructure, but, in some embodiments of the invention, adds constructs to build live and/or interactive environmental indices. In addition, a recommendation engine and social media sharing strategy is designed to give incentive to participation through both peer acknowledged and direct incentives, where the ESI bridges the interests and actions of a wide variety people and groups into a system where they can be analyzed, summarized and articulated in a universally understood set of environmental performance metrics. In an embodiment of the invention, the ESI will engage both individuals and self-selected groups in environmental improvement by translating environmental sensor information into graphical summaries of relevant indicators. Furthermore, a system for communicating not only system status, but also for measuring progress towards meeting user and group goals is provided.

It is conceived that, in an embodiment of the invention, the system delivers these services to a broad, optionally general, audience by using modern web infrastructure and/or open data standards to deliver the ESI interactively and/or as a software as service platform. This strategy supports very large and/or distributed geospatial datasets by keeping most data and geoprocessing in the cloud and/or using a global communications network, while simultaneously providing interactive access from among others, portable data devices (e.g. mobile phones and tablets) and common web browsers on a variety of devices. In an embodiment of the invention, “cloud” is a general term for anything that involves delivering hosted services over the Internet. These services are broadly divided into three categories: Infrastructure-as-a-Service (IaaS), Platform-as-a-Service (PaaS) and Software-as-a-Service (SaaS).

Ecosystem services are typically not produced in the same location that they are consumed. For example, high quality water is produced in pristine mountain watersheds, but consumed in agricultural and urban areas. This leads to large inefficiencies where privately-owned land is not managed to produce a full range of ecosystem services because markets do not exist to pay for them. One application or use of the ESI, in some embodiments of the invention, is the creation of at least local ecosystem service markets. The ESIM is described in more detail below in the ESIM Section. In an embodiment of the invention, the marketplace converts externalities into tradable goods and/or services. The marketplace implementation organizes social and/or market incentives to promote voluntary and /or commercial exchanges and/or payments, in some embodiments of the invention.

### Exemplary ESI System Embodiments

In an embodiment of the invention, a system is described which simulates reasonable future ES levels using a combination of ecological searches for relevant precedents and/or user selection of system-recommended practices. This system accounts for local fine-grained variation in ES values, including those driven by biophysical factors and those driven by local geographic and/or political circumstance. By constraining the set of practices to those with demonstrated current and prior performance in similar ecological circumstances, the system helps users to create action plans which are highly likely to succeed and/or are of high value to potential purchasers or sponsors. Because relevant economic and performance data are tracked by the system, reasonable and up-to-date estimates of local conditions are possible. This is valuable because functional ecosystem services markets need to be locally tailored and responsive to circumstances.

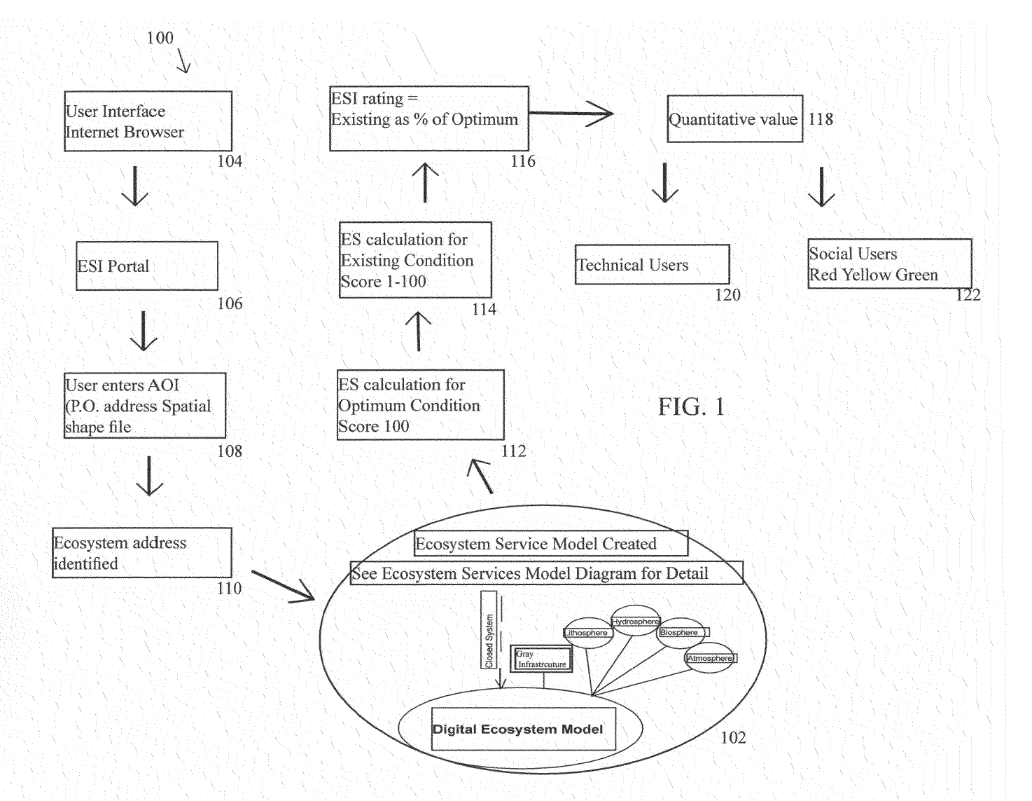

Referring to FIG. 1, a flowchart 100 of the general process for calculating an Ecosystem Services Index is shown, in accordance with an exemplary embodiment of the invention. In an embodiment of the invention, this flowchart 100 shows the process a user request travels when a request is made. The technical analysis associated with the request is submitted, in an embodiment of the invention. As explained in more detail below, with respect to Table 1 and elsewhere herein, the user does not experience the internal process, but rather receives the outcomes, in some embodiments of the invention. The outcome is optionally communicated differently to technical user like agency staff or professional consultants.

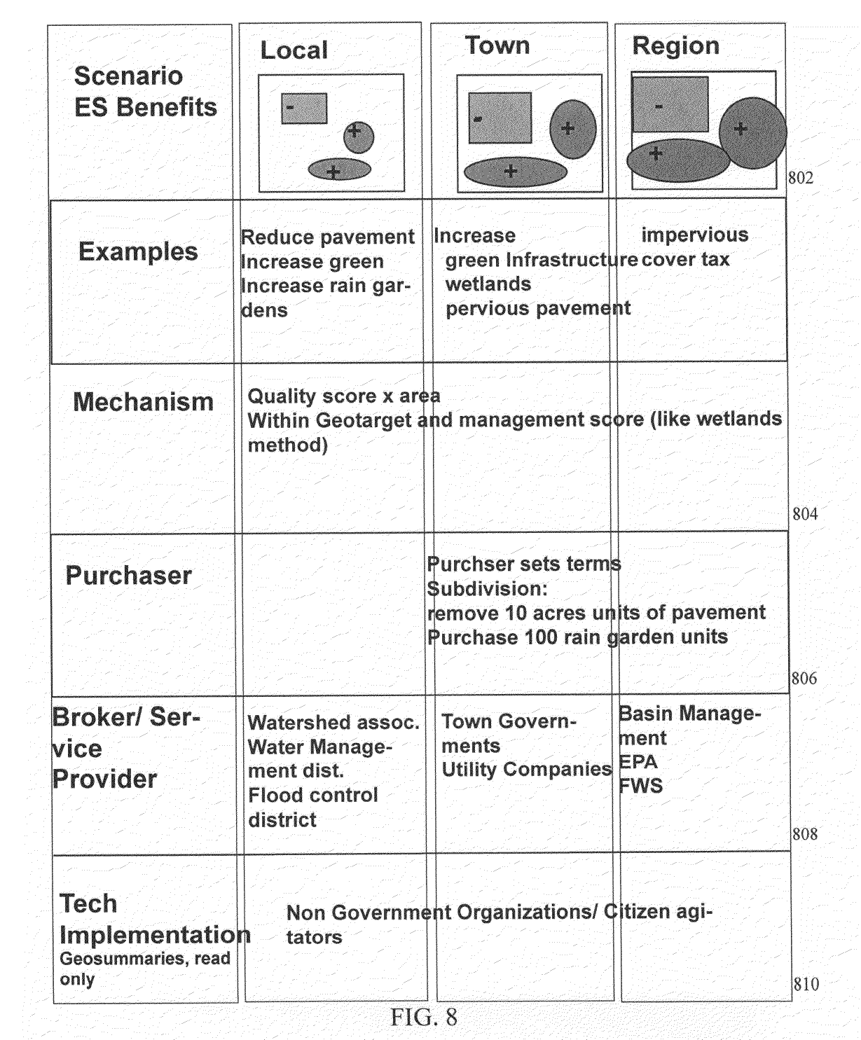

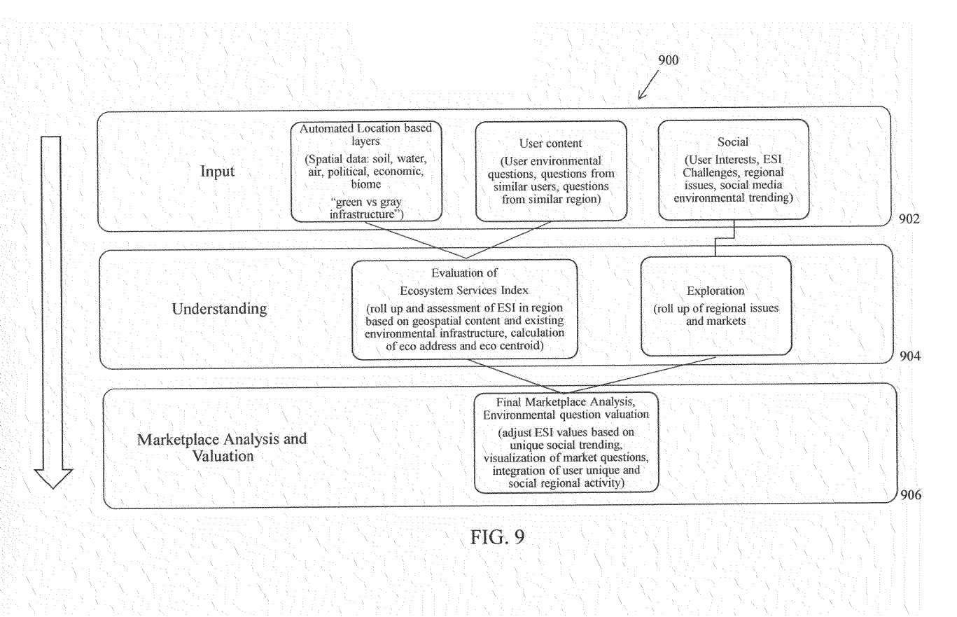

In some embodiments of the invention, the ESI system and ESIM system, described in more detail herein and with respect to FIGS. 8 and 9, are designed to measure and/or monitor environmental performance and/or to engage and measure individual and/or collective action. In some embodiments of the invention, it addresses the needs of several target audiences with different needs, interests, and/or levels of technical sophistication. In some embodiments of the invention, an “interested public” (social users 122) audience is differentiated from a set of “professional” (technical users 120) audiences. As used herein, the “interested public” has environmental concerns, but little in the way of standard environmental education and/or access to environmental data or assessment tools. By contrast, “professional” audiences, as used herein, are presumed to have at least some level of familiarity with a subset of issues, and/or often the programmatic responsibility to monitor them, but often with highly-constrained personnel or corporate resources.

In an embodiment of the invention, the systems described herein serve the two audiences by combining data streams which, to-date, have largely been considered only separately. Unlike systems which consider only broad-scale environmental data such as that derived from remote sensing, the system also tracks point-level ground-based samples, in an embodiment of the invention. Additionally, alternatively and/or optionally, unlike systems which consider only individual point samples, the methods described herein statistically aggregate individual volunteered geographic information and/or use it to inform higher level neighborhood, watershed and/or county aggregations, in some embodiment of the invention. The systems and methods described herein build performance metrics which reflect local contributions within actual geographic context. The systems and methods described herein gather key field data, including “willingness to participate” and/or detailed samples. These are used to construct or evaluate citizen and incentive-based programs, projects and/or practices, in some embodiments of the invention.

For the interested public, the system provides high-level summaries of environmental conditions which require no particular education and/or additional tools to interpret, in an embodiment of the invention. For example, indicators of relative and absolute air, water and land condition are calculated and/or provided. For those willing to engage to improve conditions, the system optionally seeks “volunteered geographic information.” This can be provided, for example, by filling out geocoded web forms, and/or submitting geotagged photos of conditions. In an embodiment of the invention, the system integrates this individually-submitted information with broader contextual information and/or authoritative data sources to show how individual and/or small group actions have affected the environment, and/or might do so. In an embodiment of the invention, this provides a powerful set of tools for designing individual and/or small-group activities, as well as for evaluating their consequences over time.

For environmental professionals, the system provides a “drill down” into the environmental indices, including full technical detail of the contributing conditions, in some embodiments of the invention. The ability to summarize indicators at particular geographic levels, which is particularly important to public officials with jurisdictional limits defined geographically, is also provided, in some embodiments of the invention. Additionally, alternatively and/or optionally, “volunteered geographic data” is requested, but in this case in the form of authoritative data streams. In an embodiment of the invention, it is conceived that the value in providing such information comes not from its narrow characterization sectorally, but instead, through the geographic and/or thematic integration capabilities of the ESI methods described herein.

The ESI is positioned to support and/or drive the consumption of environmentally friendly products and resources through calculation of the ESI 102 and/or implementation of the ESIM. The ESI and ESIM guide and/or link consumers and/or retailers to maximize the implementation of the regionally based environmental models, in some embodiments of the invention. Buyers are optionally made aware of environmentally beneficial products in their region. These may be exemplified by, but are not limited to, those impacting air, soil, water, fuels, green infrastructure, and/or chemical alternatives. Retailers are optionally given data feeds for pull and push of products or services environmentally beneficial to consumers. In an embodiment of the invention, a method showing proactive green products is highlighted, as will those receiving official fines and/or penalties.

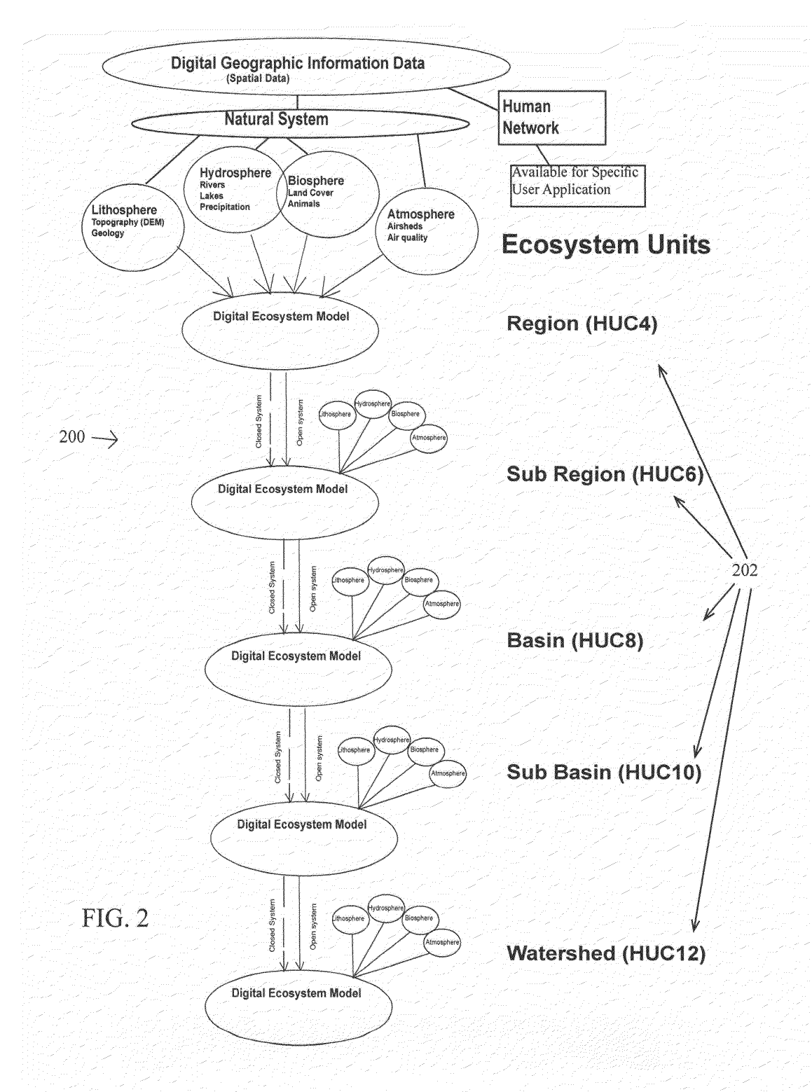

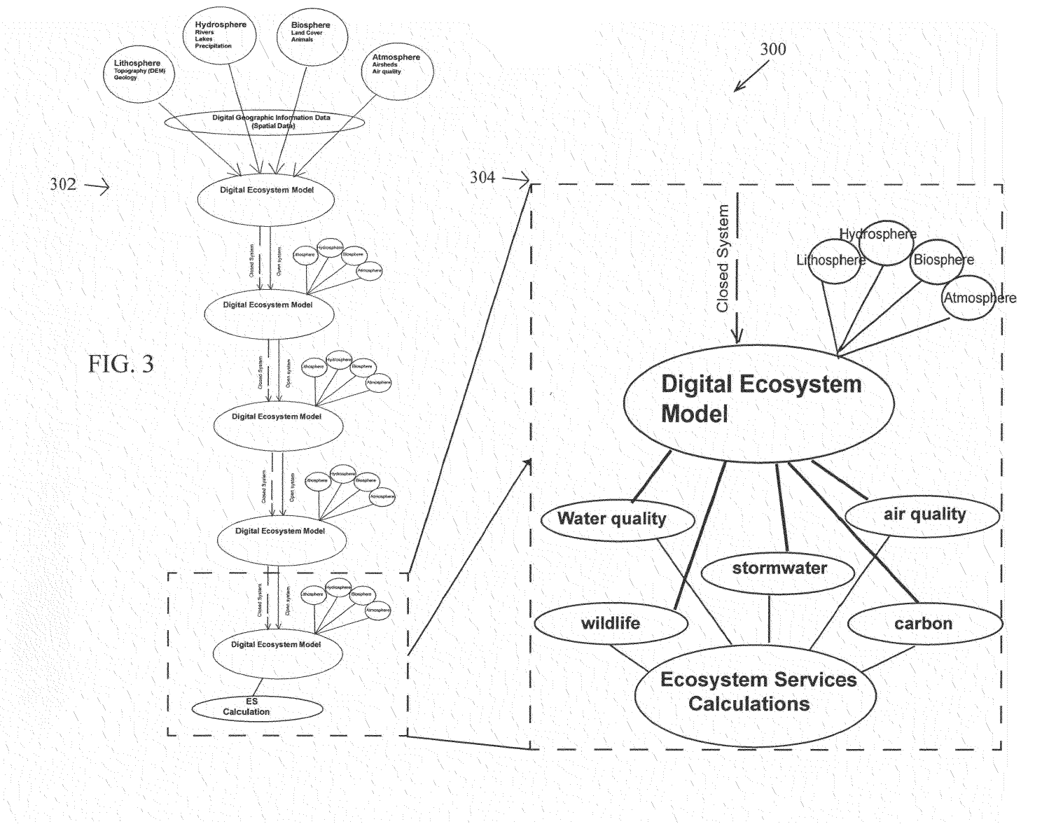

In conceptual terms, the ESI is a hierarchical aggregation of dynamically-computed environmental indicators of differing scales, centroid, and/or disparate quantified metrics, for example across water, soil, air, economic, political and living biomes, shown and described in more detail with respect to FIGS. 2 and 3. FIG. 2 is a schematic 200 showing a hierarchy and inputs for analyzing an ecosystem, in accordance with an exemplary embodiment of the invention. In an embodiment of the invention, the schematic 200 depicts the digital analysis of the function of a full scale ecosystem. The exemplary “full scale” ecosystem here is made up of 5 subsystem categories 202. There could be more or less, depending on the application and/or user requirements. A digital ecosystem model is calculated for each of the 5 subsystems (shown in more detail with respect to FIG. 3) and each subsystem influenced in part by the larger system that feeds it, in an embodiment of the invention. The ecosystem units in this case are hydraulic units (“HUC”) or watersheds so the “feeding” is drainage. This calculation can utilize other metrics of scale, such as defined by national, local or regional scales, by geopositional accuracy, or as a function of the resolution of the data set in terms attribute size versus actual. As an example this is ground sample distance the size of a pixel on grounds.

In an embodiment of the invention, the natural system provides the fundamental structure for the ecosystem calculations, and the impact of the human network at various points in time can be determined.

Indicators have quantitative numeric forms, as well as normative qualitative classifications, each with associated symbology and metadata. For example, the quantitative form of an indicator for erosion might estimate “dry rill erosion” in “tons of sediment per acre per year.” The qualitative classification might label a value of greater than x tons per year as “very high” and associate a particular symbology with this state. Indicators can have their own unique symbology, or can share symbology. For example, “stop light colors” are often used for management dashboards, where “red” indicates a problem, “yellow” represents a potential problem, and “green” represents good function. At top levels of the ESI, shared symbologies are commonly used. However, for quantitative sub-indices, it is often useful to craft customized symbology so as to best illustrate the patterns within the data (clarity at the expense of generalizability).

The methods used to generate 118 quantitative values and those used to generate normative classifications are kept separate, since in most planning processes it is valuable to separate the scientific and engineering issues involved in quantitative estimations with the social values implicit in particular normative classifications. This separation also facilitates the use of online survey techniques to establish or test normative classifications while avoiding such methods for testable estimations related to established science or engineering. Once established, however, the two types of values computation are tightly and automatically coupled so that any changes to inputs are guaranteed to be consistently evaluated.

FIG. 3 is a schematic 300 showing inputs for calculating a representative ecosystem services value, in accordance with an exemplary embodiment of the invention. In an embodiment of the invention, ecosystem services are a digital output calculated as the function of the ecosystem being analyzed (left, reduced scale side of FIG. 3 which is essentially FIG. 2) and a digital ecosystem model (right, enlarged side of FIG. 3). In an embodiment of the invention, an ecosystem service calculation is an economic output determined by measuring the functional output of the digital ecosystem model for each of the above 5 subsystem categories which are added and collectively produce an overall ecosystem service calculation.

In an embodiment of the invention, each indicator is constructed by a set of repeatable processes which transform either a sub-indicator or raw geospatial data into an index. For example, aggregate environmental quality considers land, water and atmospheric quality indicators. Water quality indicators are themselves built on at least one indicator of surface water, ground water and oceanographic water quality, in an embodiment of the invention. Surface water quality indicators are built from at least one water quality monitoring network data such as USGS stream gauges, and optionally combined with remote sensing data, and/or with user-contributed information.

In an embodiment of the invention, the quantitative and qualitative rules used by a particular indicator can vary, and aggregations can include spatial Boolean logic or additive indicators. For example, the qualitative interpretation of an erosion index might vary based on proximity to a fragile coral reef system. In an embodiment of the invention, spatial analysis includes extensions of traditional boolean logic and set theory to include concepts such as spatial proximity or intersection. Spatial analysis is optionally performed on both raster and vector data, although specific methods may vary. It is also closely tied to spatial visualization, in which results are symbolized using colors, shapes or patterns in order to facilitate interpretation. In an embodiment of the invention, “vector data” represents elements in the form of points, lines or polygons. These data elements are typically built on aggregates of point data, including explicit “boundary” representations using geographic coordinates. Typically each geographic feature contains a record locator used to associate arbitrary tabular data with features using a relational database model.

In more technical terms, a fundamental building block of the ESI is a “geoprocessing node” or geonode, in some embodiments of the invention. Each geonode is optionally a web service, which is represented on the interne using a uniform resource locator or URL. In an embodiment of the invention, the ESI establishes an application programmer interface, or API which both consumes and produces geographic data in standard formats. In some embodiments of the invention, two important formats are components of the international and/or national spatial data infrastructure(s) which support vector and raster GIS data types: web feature services (WFS) and web coverage services (WCS). In an embodiment of the invention, “raster” represents two or three dimensional data in the form of discrete spatial samples sequential ordered within a regular array. For efficiency, the coordinates, or geospatial referencing of the array is implicit. Metadata, often kept within a single file, links one or more array elements to particular ground control points with known coordinates and a georeference system. Values within the grid represent subareas within an area of interest. Values may represent raw sensor information, such as digital numbers representing light of a particular bandwidth reaching a sensor. They may also represent categorical data useful only with an associated “lookup” table. This is frequently the case with classified imagery such as raster land use datasets. Geonodes can have an arbitrary number of inputs and outputs, although a half dozen or less of each are typical.

In an embodiment of the invention, the geonode “listens” for any changes to input data. Change is listened to based on regional ESI or ESIM calculations, in an embodiment of the invention. As the input data is updated temporally the system will “listen” or watch for geospatially based changes in input data. This can come as international, national, regional and/or as user unique content. For example, a technology called Websockets is usable for this purpose. Websockets technology supports peer to peer sharing of incremental geospatially tagged changes. When a change is detected, the geonode performs any spatial analyses necessary to update its outputs, in an embodiment of the invention. Optionally, while it is processing, a geonode produces status update messages so that interested listeners can predict when processes are likely to be completed. When processing is complete, a geonode updates its output web services, including timestamps in their metadata, in some embodiments of the invention. Optionally, it also directly notifies any other geonodes registered to be interested in its results. In an embodiment of the invention, this dual mechanism allows downstream processing to be actively “directed” when necessary, but also to be passively “discovered” post-hoc. In an embodiment of the invention, the system continually reviews available geo-data sets and updates the ESI and ESIM.

Geonodes also have a geographic territory which they represent, in an embodiment of the invention. For geographically simple problems/scenarios, a geonode might span the planet but involve regional content and/or in turn be displayed at a local level. However for many common problems, a geonode's geography is scaled so that the data required to maintain its services can fit within rapidly accessible memory, in an embodiment of the invention. From a practical point of view, establishment of a specific geographic area of responsibility means that most indicators can be evaluated in parallel across multiple CPUs and/or GPUs—an important consideration in cloud computing.

In an embodiment of the invention, the system is configured to model multiple tiers of social and/or sensor based content and/or to optimize environmental action based on static, historical, and/or live geospatial data. The ESI system optionally utilizes at least one of multiple “back end” architectures in geonode construction and/or evaluation. For example commercially available systems, postGlS servers, ESRI ArcGIS Server, and/or Google's Earth Engine API are usable with the ESI system as a base preprocessing engine. ESI is not limited in theory or practice to these application types, any computing process could be used which can accept web feature services or web coverage services as inputs, and/or which produces output in either of those forms. Additionally, alternatively and/or optionally, the computing processes also access other data using other protocols not specified by the ESI system. For example, Google's Earth Engine API (GEE) can access Google “Fusion Tables” for tabular information and can reverse geocode address information in those tables. In an embodiment of the invention, a geospatially-referenced end product available at a location specified by a URL, with a timestamp of that URL correctly set according to standard web resource protocols, is utilized by the ESI API. In the case of GEE, no progress indicator can be constructed because that API does not yet specify one, but functional indicators can nonetheless be built simply by polling a GEE URL which returns a geotiff or KML file. It should be understood that embodiments of this invention can be altered in operation once the GEE API is modified so.

In an embodiment of the invention, the process of constructing an ESI indicator from scratch is accomplished by pointing to an existing resource, and specifying which states of that resource correspond to a particular indicator symbology. For example, a simple indicator of water quality is dissolved oxygen and this attribute is available from several sensor networks. If a single person or organization wishes to construct an indicator, the person or organization can declaratively do so by associating a resource URL and an indicator rule. In some embodiments of the ESI system interface 104 (described in more detail below, but typically a web browser based interface), this is specified graphically. In some embodiments of the invention, the pseudocode for such an indicator rule might look like the following:

<resource name=”DO”>

<url>”http://water?measure=DO&units=mg_L”</url>
<georss:point>45.256 -71.92</georss:point>
<poll_interval>1000</poll_interval>
<description>“Poll water quality sensor every 1000 milliseconds
at given location
for dissolved oxygen in milligrams per liter”</description>
<creator name=”Geodesign Technologies, Inc.”
url=”http://geodesigntech.com”>
<timestamp>05/01/2013 5pm</timestamp>
<version>0.1</version>

<indicator name=”water_quality_DO”>

<if>DO.value > 800</if>
<then>water_quality_DO.state = poor and
water_quality_DO.color = red
</then>

The above construct (system rule) associates a geographic resource at a specific interne URL with a specific indicator value and symbology. In addition, it provides some metadata about the construct, such as its creator and creation date and version. In some embodiments of the invention, more socially and/or technically complex indicators will form the public basis for the ESI, and/or most user interaction will be by copying and adjusting a base rule, rather than by constructing such rules from scratch.

In an embodiment of the invention, there are three overarching steps in the process:

1) Current ecosystems performance evaluation and visualization. The system generates color maps and performance indicators for any given location of interest. It uses a propriety EcoAddressing algorithm to resolve addresses, location names or zip codes to a set of ecological boundaries, and then to determine the ecological position of given sites within these units. Positioning a site within relevant ecological gradients and boundaries makes it possible to search for appropriate historic precedents.

2) Potential performance evaluation. The system uses its Ecosystem Services Potential Model and EcoSearch algorithm to find the most suitable feasible products, services and management options. In doing so, it takes into account what can be accomplished (given the difference between the existing condition 114 and the optimum or reference goal condition 112 (in an embodiment of the invention the conditions are graded on the same scale). In an embodiment of the invention, the optimum condition represents the ideal condition to improve the ecosystem service. It provides the correct amount of modification based on the need and the costs. In an embodiment of the invention, the existing condition is the state of the environment at a particular reference point. Optionally, an ESI rating is given 116 which is a function of what percentage the existing condition is of the optimum condition.

3) Social Engagement and “Calls to Action.” A set of potential calls to action are automatically generated by the system. By ranking and scoring a selected location compared to other similar ones, one or more “EcoChallenges” is generated. Participants can test the effects of taking one or more actions, both individually, and collectively. By inviting members of their community or social network, they can choose to share in a challenge.

In an embodiment of the invention, Ecosystem Services scores are valued based on a principal of “additionality”, where the actions undertaken by the user are greater than some baseline, but the baseline in any individual case is basically to follow the law and do no worse than current. In an embodiment of the invention, all management levels are used to build relationships of management and/or local context variation to ES performance in the area. In an embodiment of the invention, “BMP” is then thresholded to better than current (i.e. additional).

At each point after one or more management actions, products or services have been user selected, the system recalculates performance indicators and/or actions, in an embodiment of the invention. The recalculated performance indicators show how the prospective actions affect the ES in question directly, but also show other effects on other Ecosystem Services. For example, adding a vegetated buffer strip would not only improve erosion services, but likely also improve water quality and habitat. Other key performance indicators could include gross and net costs, and internal return on investment, or estimated payback period.

Next-step actions updates could include current relevant challenges or contests, and/or PES availability and rates given prior actions selected, in an embodiment of the invention. For example, a user might elect to take part in a local watershed challenge, with a raffle prize provided by the local water utility. Or a user might elect to create a PES offer for the three services provided by their action. This latter case could generate a handoff from the ESI/simulation portion of the interface to the ES Marketplace.

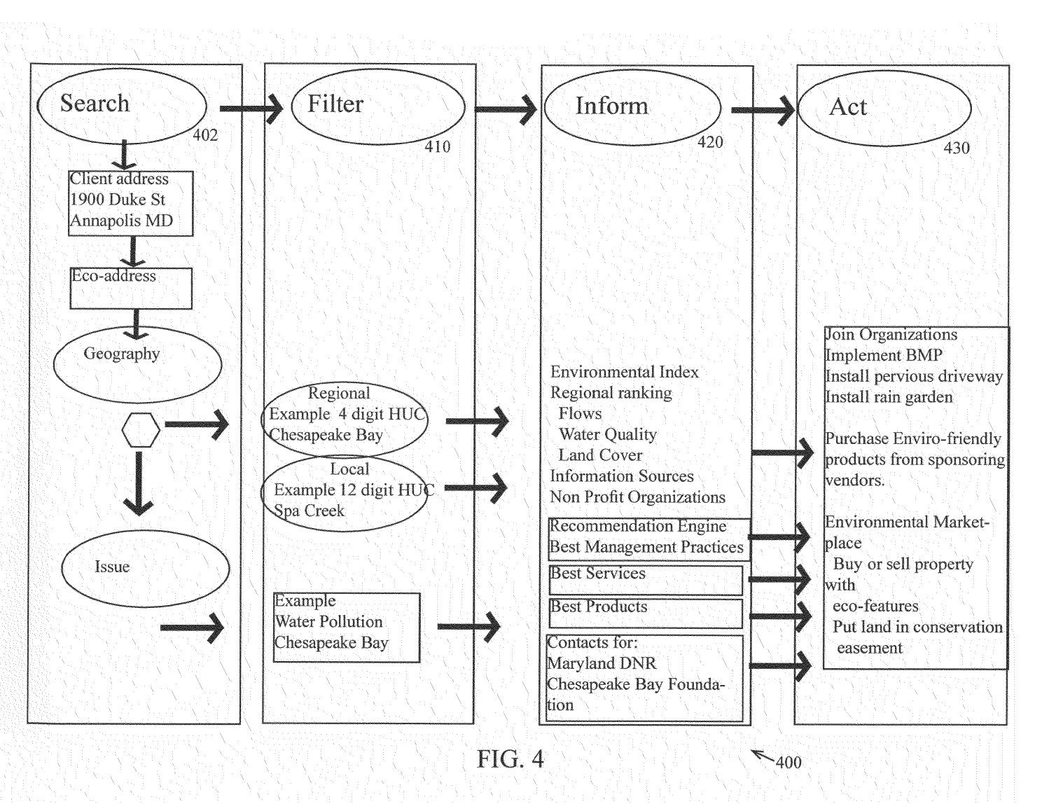

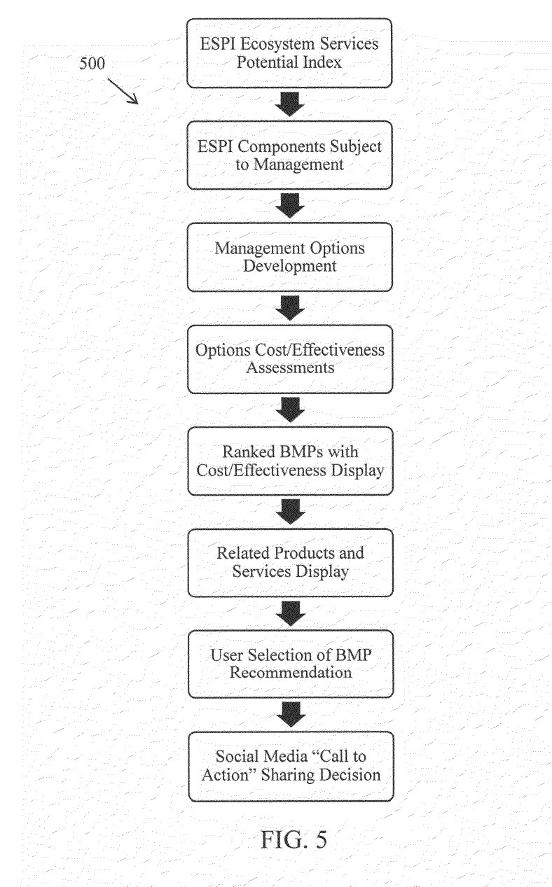

Referring to FIG. 4, a user experience flowchart 400, and in conjunction with Table 1, in accordance with an exemplary embodiment of the invention the user experience is expanded upon. In an embodiment of the invention, the user experience starts with a search 402 or request for information using the ESI system interface 104, optionally a web browser. The user's Area of Interest is translated (similar to action 110 in FIG. 1) into an ecological position or address, optionally by an ESI server 106. A digital ecosystem model is created for the ecological position requested by the user (the user area of interest is converted into an ecological framework). In an embodiment of the invention, information is generated 420 for the user, for example the Ecosystem Service Index, Regional Ranking, and/or Best Management Practices (“BMP”) produced by the recommendation engine (described in more detail with respect to FIG. 5). Optionally, information is filtered 410 prior to presentation to the user. Optionally, at least one filter is put in place by the user. Optionally, the system automatically applies at least one filter. In some embodiments of the invention, the user is provided with sufficient information to take action 430. For example, taking action includes joining organizations, buying environmentally friendly products and/or buying or selling property using the ESIM. Additional exemplary details regarding Table 1, FIG. 4 and the general process are described below.

TABLE 1
Summary of System Characteristics

| Front End User | |
|---|---|
| Experience/Interface | Backend, Middleware and Services |
| Specify Location(s) | Get Ecoaddress (lookup systems and |
| | boundaries) |
| | Find Eco-position within ecosystyems |
| | individually and/or for aggregate portfolios |
| | Ecosearch Algorithm |
| Neighborhood | Raw environmental observations |
| Eco-visionalization with | GIS data layers |
| maps and Indicators | Ecosystem Services layers |
| | Dynamic summarization reporting |
| Competitive Ecorank | Automatic computation of comparable |
| Display | ecological neighborhoods |
| Interface for User | Track user/group challenges upon updates of |
| Generation of Challenges | underlying data |
| Interface for Sponsorship | |
| of Challenges | |
| Issue Drilldown | Hierarchical nested page layouts where each |
| | refinement of issues leads to linked detail |
| | subpages |
| Best Practices Display | Best practices search using “GeoRank” |
| | algorithm |
| | Case reviews adjusted for geolocation (what |
| | works well and where) |
| Best Products and | Best products and services search using |
| Services Display | “GeoRank” algorithm |
| | Products and services ratings adjusted for |
| | geolocation (what is offered where and/or |
| | works well where) |
| Social Media Connections | External APIs (Facebook, Twitter, etc.) |
| Panel with feed screens | |

A) Front End Interface and Detailed User Experience 1) Find EcoAddress. User inputs 108 location as address, zip code, town or property (an Area of Interest (“AOI”)). System geocodes user's location and intersects with natural systems hierarchical boundaries to determine position within ecological units of importance. Ecological boundaries include watersheds, airsheds, ecoregions, habitat types, etc.
a. Stepwise search from geographic position through ecological boundary units to the smallest set of units containing the minimum number of required observations.

2) Neighborhood Ecosystem Visualization. System presents custom interactive report depicting local ecological conditions for the selected area, including maps, images and key performance metrics. Interface shows “at a glance” a consumer-oriented overview of neighborhood condition.

3) Competitive Eco-Ranking. Use Ecolndex scores and ecoaddresses to generate live ranking comparisons of user's neighborhood's ecological performance to other similar neighborhoods. Also, allow establishment of “ecochallenges” to user's social network groups, so that user can customize the groups to which their neighborhood or company is compared. User can select various social network groups to challenge, and elect to receive notice of changes in rankings or approaching contest deadlines. Sponsors can incentivize particular challenges with cash, goods or awards.

4) User Participation Issue Sections. Sections are provided for major theme groups, including air, water, species and climate. By clicking on a tab or similar interface, the user indicates areas of higher interest to them. The interface shifts to focus on that issue group, and related events, activities, case studies, and products.

5) Best Practices Recommendation Engine. “Georank” algorithm supporting a georecommendation engine selects case studies where ecological performance issues found locally have been successfully addressed. Each has an image and tag line, with additional detail page. Cases are selected based on the highest priority items to address to solve the issues of concern to the user. Local examples are shown where possible. Recommendations are scale-sensitive, so that practices described at parcel scale may be different than those recommended at watershed scale.

6) Product Recommendation Engine. Georecommendation engine selects pre-screened green products and services related to the user-selected interest area, and relevant to specific local conditions. Product source library may be in conjunction with green brand screening companies, but products will be filtered and ranked according to local interest and demonstrated effectiveness relative to the environmental issues selected.

7) Social Media Connections. Interactive, live display of groups interested in the selected issue, and upcoming events related to them. Groups working on issues selected, and relevant upcoming events will be scraped from twitter, Facebook and similar feeds.

### B) Intermediate Technical Computations (Not Necessarily Displayed to End Users)

1) Ecosystem Services Flows. From the perspective of the selected location, system computes what is “upstream” and “downstream” ecologically. For example for hydrological components, computes watershed flow accumulation and direction. Computation is optionally performed paying particular attention to pits and spikes under extreme conditions.

2) Segmentation of producers and consumers. All of those businesses and residential households “upgstream” (or up-gradient) of selected site are potential “producers” of ecosystem services used by that site. Similarly, all businesses and residential households “downstream” (or down-gradient) from the selected site are potential “consumers” of ES provided by that site. This segmentation is limited geographical by system boundaries previously determined. The lists of businesses and consumers are used internally to recommend potential candidates for buying or selling ecosystem services.

3) Computation of Ecosystem Services Potential Index (“ESPI”), an ecosystem services potential index. This index determines the range of changes in ecosystem services which a specific location is able to provide. This is used in determined which ecosystem services are likely to be possible, or viable. The recommendation engine analyzes the costs of various options, provides a list of products and services as well as incentive for action. FIG. 5 is a flowchart 500 of the general ESPI computation process for determining what ecosystem services are possible, in accordance with an exemplary embodiment of the invention.

4) Computation of high-risk scenarios affecting the ecosystem services. Some ecosystem services are more valuable under extreme conditions than normal ones. For example, flood control is more important under wet conditions than dry ones. For these types of services, exogenous events or scenarios may be generated by the system.

5) Robust optimization to reduce risk and/or increase benefits at minimal cost.

6) Estimation of ES buyer's value model for purchase, given costs of alternative measures, regulatory mandates.

7) Simulation of potential ES market, given ES buyer's value model and supplier's value model.

8) Establishment of online exchange, with objective initial pricing advice to both buyers and sellers.

9) Maintenance of connections to one or more remote-sensing monitoring networks for land cover and other changes associated with ES services.

### C) Back-End Services and Methods

1) EcoAddress/EcoPosition Computation. System geocodes 110 user's location in lat/lon, AOI envelope or bounding boxes. System returns a set of relevant ecological boundaries, and a relative position index within each boundary. The position index computations vary by system, but generally expresses position relative to critical flow paths and directions. Algorithm varies by system type but is typically a function of either cost-distance, flow accumulation, or their combination. For hydrologic systems, flow paths and floodplains are computed and position is considered relative to those. For species or habitat-based systems, position is based on landscape ecology metrics for interruption of core habitats or key corridors. For airsheds, flow direction and accumulation is also used, but with atmospheric dispersion and terrain used to characterize position. For fire-related systems, flows are typically uphill, with steep areas and heavy fuel loads contributing to intense flows.

2) EcoNeighborhoods. System intersects AOI with natural systems hierarchical boundaries to determine ecological units of importance. Ecological boundaries include watersheds, airsheds, ecoregions, habitat types, etc.

3) Neighborhood Ecosystem Services Visualization Support. System generates interactive report elements depicting local ecological conditions for the selected area, including maps, images and key performance metrics.

a. Maps—generated use online geographic information system and related data services.

b. Images—drawn from online library based on keywords and geographic metadata

c. Ecosystem services are computed based on a variety of published metrics, such as the Stanford InVEST models which can be found at naturalcapitalproject.org/models/models.html, the disclosures of which are incorporated herein in their entirety. Values are normalized using the “ecosystem services performance index” approach, and then values for systems selected in the interface are summed. This approach supports both an overall EI score encompassing all input systems, and sub-reports for details.

d. Performance metrics—system performs on-the-fly aggregation of geographic values, normalizing based on reference cases (such as natural conditions model, or BMP theoretical max values).

4) Competitive Eco-Ranking. Use Ecolndex scores and ecoaddresses to generate live ranking comparisons of user's neighborhood's ecological performance to other similar neighborhoods. Also, allow establishment of “ecochallenges” to user's social network groups, so that user can customize the groups to which their neighborhood or company is compared. User can select various social network groups to challenge, and elect to receive notice of changes in rankings or approaching contest deadlines. Sponsors can incentivize particular challenges with cash, goods or awards.

5) User Participation Issue Sections. Sections are provided for major theme groups, including air, water, species and climate. By clicking on a tab or similar interface, the user indicates areas of higher interest to them. The interface shifts to focus on that issue group, and related events, activities, case studies, and products.

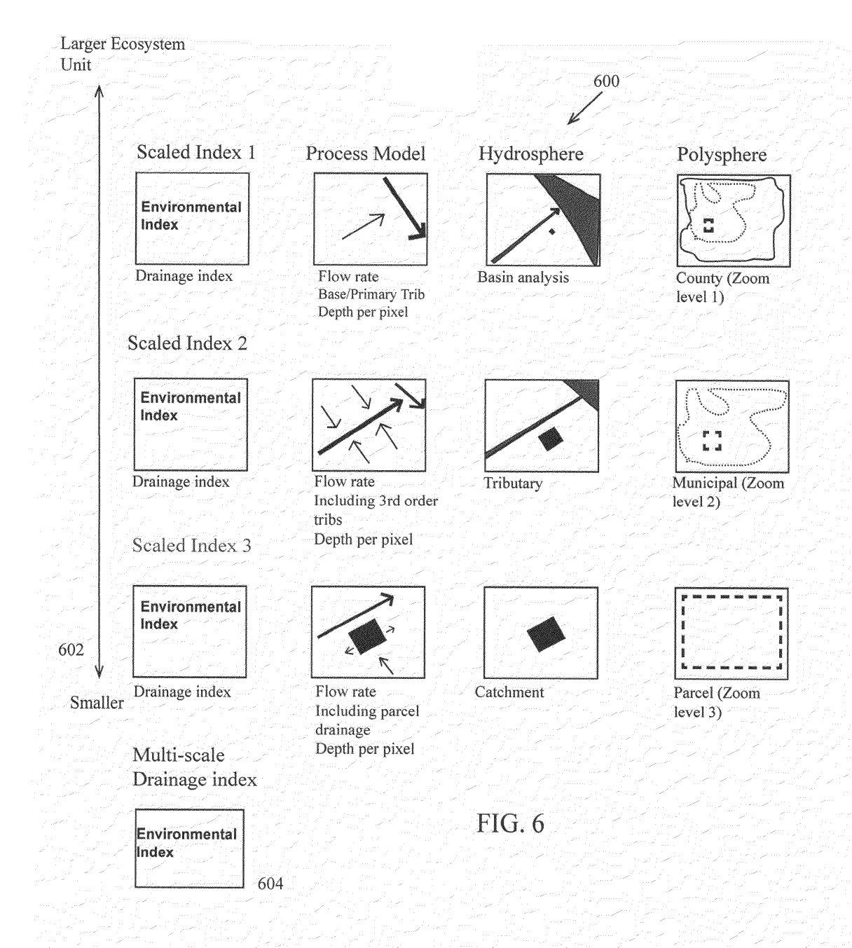

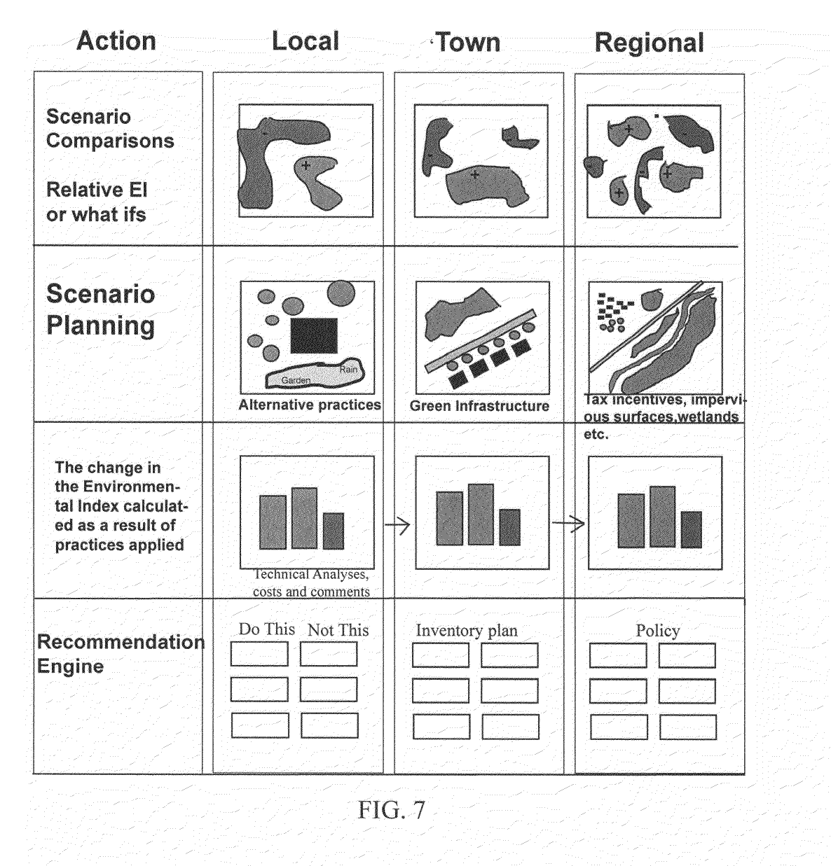

6) Best Practices Recommendation Engine. “Georank” algorithm supporting a georecommendation engine selects case studies where ecological performance issues found locally have been successfully addressed. Each has an image and tagline, with additional detail page. Cases are selected based on the highest priority items to address to solve the issues of concern to the user. Where possible, local examples are shown. Recommendations are scale-sensitive, so that practices described at parcel scale may be different than those recommended at watershed scale. FIG. 6 is a schematic 600 example of a multi-scale environmental index calculation; in accordance with an exemplary embodiment of the invention. In an embodiment of the invention, the ESI is calculated at various scales ranging from a large area like a county to a small area like a parcel (as shown in the scale 602 on the left side of the page, where the largest scale is at the top and the smallest is at the bottom). A mathematical average value 604 of the various scales can also be determined. In the Process Model column, one ecosystem service index calculation (for “Flow rate”) is represented, in accordance with an exemplary embodiment of the invention. The Hydrosphere column shows the conceptual view of the ESI analysis using the hydrology data, in an embodiment of the invention. The Polysphere column shows information which represents political and/or ownership boundaries.

7) Product Recommendation Engine. Georecommendation engine selects pre-screened green products and services related to the user-selected interest area, and relevant to specific local conditions. Product source library may be in conjunction with green brand screening companies, but products will be filtered and ranked according to local interest and demonstrated effectiveness relative to the environmental issues selected. FIG. 7 is a charted example 700 of a practical application of the ESI and/or for providing product recommendations, in accordance with an exemplary embodiment of the invention. The top row of the chart 700 represents existing conditions determined from digital data at three scales (small to large, local to regional). Scenario Planning (second row) shows how land use planning options can be calculated using the ESI, in accordance with an exemplary embodiment of the invention. After an ESI value is determined for each scenario they can be evaluated for decision making (third row). And finally (bottom row), multiple land development scenarios in multiple scales can be evaluated in a digital recommendation engine and used for land use planning and/or public policy, in an exemplary embodiment of the invention.

8) Social Media Connections. Interactive, live display of groups interested in the selected issue, and upcoming events related to them. Groups working on issues selected, and relevant upcoming events will be scraped from twitter, Facebook and similar feeds.

### Exemplary Challenges Using the ESI

The traditional purpose of an index is to synthesize and communicate quality information. However, in some embodiments of the invention, the ESI system facilitates participation in environmental quality improvements through individual and/or collective action. To support participatory use of the ESI, in an embodiment of the invention, social media hooks are embedded into several stages in the process. In an embodiment of the invention, the ESI is paired with the concept of an “ESI challenge” or simply “challenge”. In some embodiments of the invention, any user of the system can issue a challenge, which is optionally an attempt to improve an overall index score or any component of it within a defined time period.

In an embodiment of the invention, the creation and/or sharing of challenges is built-in to the ESI system. For each item in the ESI where performance is unsatisfactory, the ESI recommendation engine will search for and/or present potential solutions, in an embodiment of the invention. The solution base is optionally seeded with professionally researched and/or written case studies illustrating individuals, business, communities and/or other organizations which were able to improve their ESI score. Challenges are optionally automatically defined based on regional demographics and/or environmental conditions. Users can review these potential solutions, and create personal or group “challenges” based on them to forward to friends or colleagues, in some embodiments of the invention. Challenges may further cross between multiple geographical regions.

Participants in a challenge can contribute data, including their opinions about various potential solutions, and/or their willingness to undertake or support particular actions. At regular intervals specified by the challenge creator and/or set by participant preferences, participants will receive social media updates about their progress, including the impacts of their direct and indirect actions towards ameliorating the indicator. Since personal actions include recruiting others to the cause, impact updates include not only the results of individual direct actions, but optionally also those of others invited by a person. For certain challenges, participants will receive digital “badges” as a token of appreciation, and/or optionally to display on their social media pages. For “sponsored” challenges, additional incentives can also be provided. For example, these might include discount coupons for relevant merchandise or services or monetary benefit. Sponsors of challenges also optionally receive regular reports about progress, including independent cross-validation work if required. In some embodiments of the invention, aggregated groups receive environmental benefit through data compilation showing positive impacts in regional, state, and federal environmental mandates.

In an embodiment of the invention, the technical implementation of the challenge system has at least two parts. The first is a recommendation engine. As mentioned above, this is optionally, initially seeded with professionally-generated content. Over time however, the system participants themselves can generate new solutions, which they will be encouraged to share, in an embodiment of the invention. These recommendations are in the form of short case studies with associated action items. Each action item has an associated “point value” with more difficult or expensive actions given larger numbers of points.

In an embodiment of the invention, the second technical component of the challenge system is a social media manager. This manages user profiles and/or social media account permissions. In an embodiment of the invention, any index component and/or challenge component can be “liked” with a button click. Similarly, these items and/or user comments about them can be posted to social media systems directly from within the ESI system user interface (described elsewhere herein). Additionally, alternatively and/or optionally, users create challenges and/or “invite” their social media friends to them. Optionally, the user specifies some challenge parameters. All of this is optionally managed at the interface level on a user profile page, and/or optionally at a technical level using an open source web middleware system, for example “geoDjango.”, described in more detail below

In an embodiment of the invention, the challenge is depicted in a game-like environment (“game-ification) to a user of the system. For example, the ESI system guides and/or models environmental impacts based on spatial location graphically for the user. This live game like environment continuously monitors and/or guides users at multiple aggregated tiers of interaction, in some embodiments of the invention. This continuous spatial feedback can be relayed to users, connected and/or disparate challenge groups to continually motivate action.

### The Ecosystem Services Index Marketplace

As previously noted, ecosystem services are typically not produced in the same location that they are consumed. For example, high quality water is produced in pristine mountain watersheds, but consumed in agricultural and urban areas. This leads to large inefficiencies where privately-owned land is not managed to produce a full range of ecosystem services because markets do not exist to pay for them. In an embodiment of the invention, the ESI system automatically and scalably computes ecosystem performance indices and, further, designs local ecosystem service index markets. This converts externalities into tradeable goods and services. The system optionally organizes social and/or market incentives to promote voluntary and/or commercial exchanges and/or payments.

FIG. 9 is a summary chart 900 of the roll up of sample data layers to a basic ESIM analysis, in accordance with an exemplary embodiment of the invention. It follows how regional awareness may be melded to derive a final simplified visualization based on layers, location, the region and social awareness. In an embodiment of the invention, Input 902 are automatically and/or manually entered data sets to be used for calculations and/or making recommendations. Automated layers are input from a user rendered or gps read coordinate and are layer values from national databases, in an embodiment of the invention. These are represented but not limited to watershed boundary, soil type, or land cover in example. Manual data is represented by, but not limited to, user input of local condition, images of their location, and/or ground truth of vegetation. In an embodiment of the invention, “social” depicts challenges between users as well as activities or issues within a region. In an embodiment of the invention, Understanding 904 is the basic calculation of index, centroid and/or address calculation and/or the communication to the user. In an embodiment of the invention, this is presented as a simplified graphic depiction condition and/or as a more detailed report depending on user type and sophistication. In an embodiment of the invention, the exploration box showing a summary of other studies salient to the user's interest. In some embodiments of the invention, these act as a guide to the user to explore other areas the user had not considered (this analogous to a customer recommendation engine based on the similar interest of others). In an embodiment of the invention, the Marketplace Analysis and Evaluation 906 is the final analysis based on all inputs and changes at the understanding level.

In an embodiment of the invention, the ESIM combines two types of systems not previously integrated: a real estate reverse auction and a dynamic ecosystem services evaluation index. The auction system provides both buyers and sellers with a mechanism for efficiently determining the best price given market conditions. Unlike conventional real estate transactions, ecosystem services agreements are performance-based contracts which extend over time. The ecosystem services evaluation system ensures that the services on offer are providing the values required, both at the time of purchase, and over the term of contract.

An auction system is needed for green infrastructure for at least two reasons. A first reason is that traditional program-level purchases are inefficient for buyers. Utilities and government agencies, which are frequent purchasers of these products, have neither the interest nor the expertise in management of real estate portfolios. From the point of view of such purchasers, programmatic costs and transactional costs are very high, as are risks of non-performance.

A second reason for developing a transparent, open market is that the myriad existing green infrastructure purchase programs are needlessly complex for sellers. A land owner or manager does not typically have time or resources to consult with dozens of agency web sites and separate program requirements. They have some portion of land which they own or control which is not yielding the level of return they require, or they are looking to provide land stewardship using methods which will avoid development and keep lands under their control.

Unlike conventional fee-simple land transactions, green infrastructure and Payment for Ecosystem Services (“PES”) deals involve a forward promise to deliver services. However regardless of good faith and initial intentions, ecological systems can be difficult to manage, particularly over long time periods. Also, personal, business and environmental circumstances can change. The ESI underpinning the ESIM system works, in some embodiments of the invention, by quantifying ecosystem services in an objective and repeatable manner. In an embodiment of the invention, it uses repeated “remote sensing” and/or satellite image analysis to ensure ecosystem performance at broad spatial scales. In an embodiment of the invention, it uses stratified field sampling integrated with this remote sensing to measure performance aspects which can only be assessed on the ground.

This combination provides assurance to both parties. Purchasers have confidence that they are getting what their taxpayers, rate payers or shareholders are paying for. Not only do they receive regular monitoring reports, but they can check for themselves at any time from any computer or mobile device with an Internet connection. Sellers have confidence that their successful land management efforts will be recognized and rewarded, without having to personally conduct or commission either remote sensing or biological field work. This model works well for most sectors, for example flood protection described in FIG. 8.

FIG. 8 is a charted example 800 of applying the ESI to real estate transactions and/or public policy formation with respect to flood protection, in an exemplary embodiment of the invention. The application of the ESI for real estate transactions or public policy formation is illustrated at various scales (local, town, region), represented in the top row 802 of the chart 800. In an embodiment of the invention, the mechanism 804 is the object of trade used to exchange/swap/buy one object for another. In an embodiment of the invention, they are objects of currency for transfer of environmental objects. These are represented by, but not limited to, conservation easements, transfers of development rights, payments for biological services and payments for hydrological services.

An ESI calculation produces a standardized value to a property (large or small) that allows a purchaser 806 or seller of property as well as a policy maker a digital tool for evaluating an action. In an embodiment of the invention, the broker/service provider 808 assists the purchaser 806. The technical data 810 is available to NGOs and other citizens so they can advocate a cause. In an embodiment of the invention, the marketplace implementation organizes social and/or market incentives to promote voluntary and /or commercial exchanges and/or payments.

In an embodiment of the invention, the ESIM system has four major “modes” of operation, designed for common customer application. These are “Buying”, “Selling”, “Servicing” and “Market Making.” A user self-identifies interest in one of these four categories by clicking a large button on the home page. From this point forward, the user interface experience is customized for a particular use, in some embodiments of the invention. Each of these types of customer situations are described in more detail, below.

Buying

Buyers in this case are most often individuals working for large institutions. The largest single buyer in the U.S. is the Natural Resource Conservation Service, which last year spent in excess of 60 Billion dollars. The needs of states and counties are more modest, but still collectively account for hundreds of millions of dollars per annum. Much of the state activity is organized according to particular agencies, such as departments of transportation, which are required to conduct considerable mitigation for the large projects they perform. Finally, utilities and other large private companies are also large current purchasers of conservation lands and easements.

A major challenge in this large purchaser scenario is that these institutions have developed their PES programs based on agency and institutional needs which are quiet diverse and often not well understood by outside parties. Reflecting these needs, the system allows buyers to organize potential purchases in much the same interactive manner as used for sellers, in an embodiment of the invention. Instead of “offer scenarios”, this interface supports the development of “Ecosystem Services Programs.” The basic components are also identical: thematic areas, and geographies. However there is one notable difference, which is in this case there is often a need to “offset” or “mitigate” harm to the environment done in one area with similar lands in another. Therefore, there are potentially two geographies in play. The first generates demand, and the second defines supply. In an embodiment of the invention, a capability provided by our system is to account for habitat quality as well as amount on both sides, and/or to make it much easier for buyers to design programs than could be done with previous methods.

The top-level choice for buyers within program creation is to specify what drives or limits their demand. The most common options are cash budgets, land area goals, and project mitigation needs. Budget-based purchases proceed from the point of view of designing an auction which purchases the most and best ES available, at the lowest cost. If there is a particular land area goal, then the auction design is similar, except that it must take into account land caps. In both cases, the potential buyer creates a program design which specifies the “rules” under which the auction is to be conducted, in some embodiments of the invention. These rules can be geographic or thematic requirements, for example. As a specific example, a state agency would commonly first limit geography to its state. If it is a forestry agency interested in a particular habitat type, it might also specify that.

Because the institutions and geographies involved are potentially complex, this interface is somewhat more elaborate than that designed for sellers. In particular, it is assumed that geographies may in these cases be too complex and non-standard to pick or draw by hand. For this reason, the system is configured to support GIS or CAD file upload, in an embodiment of the invention. In some embodiments of the invention, this is a capability supported by the middleware component, which then records the data into the backend database. For example, if the hypothetical forestry agency only wants to purchase “long-leaf pine” in their administrative region x, they can specify one or both using standard file formats.

Once potential source and destination geographies are identified or uploaded, the matching process proceeds similarly to the seller side, in an embodiment of the invention. Current and prior transactions meeting program specifications are optionally identified using spatial and attribute queries. At least one index is computed from these transactions, with general ones being displayed by default, and more specific ones available using simple filters, in an embodiment of the invention. Based on these prior transactions, buyers can optionally estimate budgets and/or potential acreage counts.

In an embodiment of the invention, all of this remains private to the buyer, organized as program scenarios. Multiple scenarios can be tested, for example varying the rules or the budget. Because offline agency approval is typically needed in order to finalize a program, a set of user report templates can be generated from the program scenarios. The text, graphics, and/or tables from these templates can then be edited to agency requirements using common word processing and spreadsheet environments and published or disseminated as legally-required. When the individual responsible has authorization to proceed, they can elect to publish an offer.

Selling

A potential seller can “browse” all options, or can elect to “build an offer”, in an embodiment of the invention. Browsing is optionally supported in stock-exchange style, with ticker indices summarizing current market trends in each submarket. For example, the ESIM system tracks current purchase prices per acre for biological PES across all marketed species. The user chooses to look more specifically by selecting various thematic and geographic filters, in an embodiment of the invention. For example, a seller in Iowa might be more interested to know the index of species PES sales in Iowa, or the index price for wetlands in his or her county. The browsing interface provides this capability.

The “build an offer” function is optionally triggered from within the browsing mode, or in its own right independently. Offers are experimental scenarios, allowing sellers to quickly build a package of ecosystem services which are provided by the environmental object. For example, a first wetland providing x acres of land cover for a second (possibly destroyed) wetland in another location where the quality of the first wetland to absorb pollution, sediment, etc. is weighed against a wetland from the second location, and where both have an ESI calculated so that a comparison of two disparate wetlands can be made. Such a calculation of the ESI for the wetlands is exemplified in the Ecosystems Services Calculation 304 of FIG. 3.

of greatest benefit to them. In an embodiment of the invention, they are confidential by default; until and unless the user chooses to explicitly publish them. Similar to the browsing options, two factors drive offers, in an embodiment of the invention: thematic and geographic data. A potential seller can optionally elect to specify geography of interest using several different methods of increasing specificity. For convenience, a range of standard geographies are optionally provided. Zooming in on a dynamic map reveals these choices hierarchically, depending on map zoom scale, in some embodiments of the invention. Areal units optionally include states, counties, watersheds and/or zip code. General place search lookups can be done by name, street address, GPS coordinates and/or lat/lon location. In some embodiments of the invention, a user can sketch an arbitrary management area on the map, to get the most precise answer possible.

The rationale for supporting wide selection methods is at least twofold, in an embodiment of the invention. First, this makes it easy for a wide variety of people to use the system given information they know. Second, this allows the seller to be as specific or as general as they please in their offer, allowing considerable anonymity, if desired. This factor can be important for land owners interested in weighing several options, and not willing to tip their hand exactly.

Initial screening feasibility is provided for all supported transaction types, in an embodiment of the invention. For example, for endangered species, the system screens to ensure that the proposed location is within the current known range for the species. For hydrological elements such as water storage or flood control, the system checks that the proposed site is upstream of the buyer, and optionally within a management area which the buyer may specify. In both cases, the system also optionally screens against basic land cover and/or impervious surfaces, to ensure that the offered area is suitable for green infrastructure transactions.

In an embodiment of the invention, online mapping of “offer area” selection is performed using relatively standard GIS techniques, including scale sensitive cartography, and/or using 3^{rd} party web map service providers. This is optionally coordinated in Javascript using web mapping APIs. In the case of custom definition of an area, the actual polygon drawn is uploaded from the client to the server, in some embodiments of the invention. In other cases, the interface is optionally limited to picking from those units visually displayed at a particular scale.

In an embodiment of the invention, once a geography of interest is selected or created, the system does a spatial intersection test against all pending and/or historic purchase requests, and returns to the potential seller a list of possible services, as well as their current price and historic price range. The seller optionally elects to “stack” service offers, such as hydrological and biological services. The system then optionally computes the expected annual PES expected, and/or any cash and/or non-cash assistance available (such as agricultural cost-shares). The seller can optionally use the tool to develop or refine his or her “offer” as desired, including trying out various potential portions or sections of a larger land area.

Additionally, alternatively and/or optionally, the system dynamically pulls up available consulting and landowner assistance contact info relevant for the area and the services on offer. This allows a land owner to request in-person help, ranging from voluntary services provided by farm services agencies to private ecological and hydrological evaluations for particular species or wetland types. The seller is under absolutely no obligation to use these particular providers, but those meeting the buyer's specifications are listed, in an embodiment of the invention. For example, wetlands banking often requires experts which have been approved by the buyer.

In some embodiments of the invention, from the seller's perspective, the service provides a dynamic list of matched potential buyers at all times. In some cases, a program has annual limits, caps and/or deadlines which may already have been exceeded. In those cases, relevant historical listings are shown (possibly indicated in a distinguishing fashion like a different color text) so that the seller can understand the likely potential. If the seller chooses, they can opt-in for an automatic reminder of annual program deadlines via email or social media, in an embodiment of the invention.

Servicing

A third category of users are environmental professionals who monitor conditions using ground-based methods. This includes, for example, both field biologists and hydrologists. When and where appropriate, these “servicers” can be contractually agreed on by buyers and sellers. The ESIM system provides a centralized online location to find such servicers, and supports them over time, in an embodiment of the invention. In particular, it provides them crowd sourcing

Market-Making

The ESI and ESIM are used to answer and/or recommend environmental actions. These will provide recommendations to different tiers of users on risk mitigation and remediation. One possible recommendation is using the ESIM for acquiring and/or selling parcels with certain ESI scores which once acquired or sold satisfy a user's environment objective. Exemplary marketplace applications for using the ESIM include:
Runoff from chemical/natural fertilizers, pesticides and herbicides
Tree harvest for paper and fuel's impact to landslide and native species
Urban sprawl greenhouse impact and resource use
Utilities demand for heating and cooling
Recycling benefit
Fuel loading fire risk
Alternative fuels/ renewable energy geothermal, solar, wind turbines
Existing resource efficiencies on water and energy conservation
Reforestation plantings in critical areas
Recycle and repurpose
Buying greener technologies

### Exemplary Hardware and Software of the System

In an embodiment of the invention, the system architecture comprises two “front ends,” a “middleware” component, and two back ends. In an embodiment of the invention, the front ends are two forms of user interface code, built using commercially available software solutions, such as the HTML5 standard, Javascript, and/or CSS. The first is designed for desktop GIS use, and the second for mobile devices. Optionally, different user interface libraries are used in order to optimize user experience on both device types.

The middleware is a tool known as geoDjango, in an embodiment of the invention. This is a Python library which provides large-volume user account administration and interfaces between Javascript APIs on the front end, and database languages such as SQL on the back end. However, in some embodiments of the invention, other implementations are possible with different middleware and back end services using the same or similar business logic. For example, user authentication and account administration could be delegated to a web service, and/or JavaScript-based Node.js could be used to manage similar database objects on the server. In addition, the development of more advanced geo spatial web services may allow geonodes to be distributed and computed across heterogenous systems.

In an embodiment of the invention, the system uses a data model based on three fundamental tables. In other embodiments of the invention, less or more tables are used. Buyers, sellers, agents and proponents are all subtypes of users. It should be understood that other types or subtypes of users could be defined and that buyers, sellers and agents are merely possible examples. Offers and requests are subtypes of ecological real estate transactions. These are further broken down into common mechanisms, such as conservation easements, transfers of development rights, payments for biological services and payments for hydrological services. Although it is less common to date, the system architecture also optionally contains transaction types for carbon sequestration, following the UN REDD protocol for forested areas, and the “Blue Carbon” initiative for coastal and marine areas. Because the data model supports subtypes and “mixing” classes, this mechanism is flexible as new PES programs are developed over time.

In an embodiment of the invention, the first back end is a tabular and spatial database server, for example postGIS 2.1. The spatial component of the database is used to store ecosystem services assessments, in an embodiment of the invention. These are mostly “ecological index” resource layers, and management summary units, in some embodiments of the invention. Each geonode supports the evaluation of a particular type of ecosystem service, in an embodiment of the invention. Inputs are optionally pointers to web geospatial resources, such as remote sensing specular data or processed classifications. In some embodiments of the invention, outputs are of two kinds. The first kind is a quantitative estimate of relevant ecosystem service values, such as habitat suitability indices. The second kind comprises qualitative judgments of these indices, as managed by service providers.

In some embodiments of the invention, each potential ES transaction can involve one or more management summary units, and/or one or more resource layers. For example, a single-use PES program might purchase “gopher tortoise habitat” for a single parcel. This would be represented in the database with a management layer containing the parcel and a resource layer containing a current conditions assessment of gopher tortoise habitat. In an embodiment of the invention, the system is configured to provide several levels of assessment, including an initial feasibility screening, a remote-sensing analysis, and/or a field-validated analysis. In an embodiment of the invention, “layers” are a paradigm for the display of geospatial data which emulates traditional media in that it is order-dependent, and the latest items added by default obscure prior additions. Layers contain either vector or raster information, and can also include associated descriptive content such as text, images or tables. Layers must contain some form of geographic coordinates, either geocentric or relative to a planar projection system. These coordinates can be explicit within the data stream itself, or implicitly derived by tabular association or web lookups. For example, a list of addresses with state names can be represented as a layer either by reverse geocoding web services or by database joins associating records with particular geographic features.

In an embodiment of the invention, the second back end is a remote sensing system. This is optionally an interactive online system such as Google's Earth Engine, or is optionally based on conventional desktop Remote Sensing systems such as ERDAS Imagine. Remote sensing classification work starts with raw spectral imagery, and uses image processing and/or statistical techniques to convert this data into land cover categories or qualities, in an embodiment of the invention. Within the system, the remote sensing component is used initially to screen properties for appropriate land cover, and over time to monitor the persistence and/or quality of this cover, in an embodiment of the invention. The resulting analyses are optionally stored locally and/or are uploaded electronically to cloud-based GIS servers and/or are transmitted to users of the system and/or are published as spatial web services. In an embodiment of the invention, these analyses are used to create, or to update, ecosystem services evaluation models.

In an embodiment of the invention, the ESI server 106 receives input/requests from the user through the user interface 104 and/or is the processor which processes the requests, for example identifying the geonode, assigning the ecoaddress, calculating ESI scores/values, calculating optimum conditions, calculating existing conditions, calculating an ESI rating, deriving recommendations based on calculations, and/or identifies ESIM offerings relevant to the recommendations and/or calculations. In some embodiments of the invention, the ESI server 106 is remotely located from the user. Optionally, the ESI server 106 is in communication with the user and/or informational databases via a global communications network.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non-limiting fashion.

### Example 1

Taking a scenario where the service in question is riparian forest cover, the remote sensing system is used initially to assess historic and current riparian forest cover. This is based on spectral information from satellite data, in this case using the infrared bands of imagery in order to distinguish riparian forest based on its water content. It is also based on distance uphill from streams and rivers, which is an analysis of the National Hydrological Dataset (NHD) of hydrological centerlines and the National Elevation Dataset (NED) for terrain elevation. By looking for “wet” vegetation horizontally and vertically near known water features, the system can consistently identify “riparian forest.” Once this is done, and a contract is issued for the restoration or protection of such areas, subsequent remote sensing data is used to perform “change detection.” The system assesses the presence or absence of riparian forest, and determines information about its quality. This information is aggregated within the ESI to performance metrics which are the basis for the ecosystem services contracts. For example, a contract might involve the restoration of 10 miles of riparian forest using cattle exclusion and planting. Currently, there isn't a way to directly or reliably assess fencelines or seedings from current-generation imagery. But a performance end point (e.g. an ecological goal or objective) can be measured—which is forest establishment in the area of interest. This can be done seasonally for the period of the contract, and this allows the buyer of the ecosystem service high confidence that performance goals are being met over large areas and multiple ownership and access conditions. This is not possible with currently available systems or technologies.

### Example 2

Example 2 is a comparison between the EPA EnviroAtlas tool and the systems and methodology of the present invention. The EPA EnviroAtlas consists of a large digital library including a spatial data library which allows users to research published information on a wide variety of topics and build maps using spatial data for analysis using desktop GIS. The EnviroAtlas and the ESI system (i.e. of the present invention) are very different and those differences start with their fundamental approach to the environmental analysis and the corresponding interface with users.

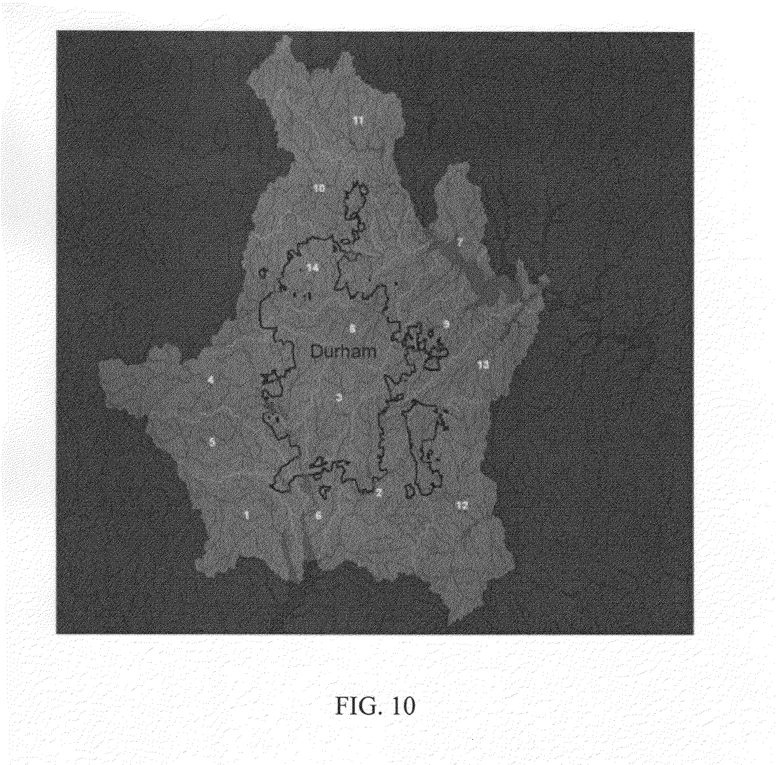

In some embodiments of the invention, environmental analysis conducted with the ESI system is based on an analysis of an ecological unit, like watersheds. Watershed units are spatially documented as GIS shape files and categorized by Hydrologic Unit Codes (HUC) from 2 to 14. However, the EnviroAtlas does not require environmental analysis to be conducted by environmental units and in fact shows users how to conduct an analysis using political boundaries rather than environmental units in their on-line examples. Referring to FIG. 10, a map of Durham, NC is shown as viewed by the ESI system. The area contains 14, 12 digit HUCs (the bounded shape files with numbers) and one political unit (i.e. the Durham NC city limit, bounded by black). However, the on-line examples used for analysis in the EnviroAtlas are based on the city limits. See http://enviroatlas.epa.gov/enviroatlas/Tools/EcoHealth_RelationshipBrowser/introduction.html

In an embodiment of the invention, a standard ESI analysis does not use the political boundary to determine an ecological phenomenon (although it could). One to 14 of the HUCs would determine the extent of the data for the analysis depending on the user. For example, the government might use all14 of the HUCs while a home owner might only use one.

A second fundamental difference between the systems is that the EnviroAtlas provides analysis tools that require the users to have additional GIS software. In an embodiment of the invention, the ESI system is entirely web based and does not require the users to have any additional software.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### Example 3

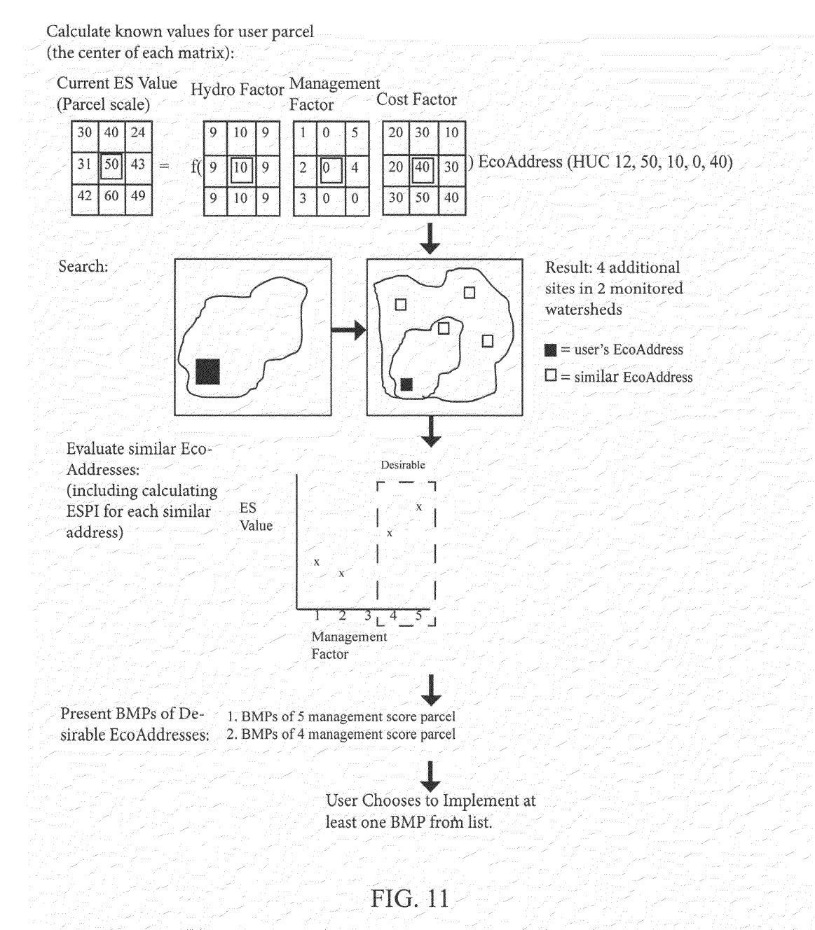

Referring to FIG. 11, an exemplary user scenario 1100 is presented where the user is utilizing the ESI system and methods described herein to determine possible courses of action given a particular objective. In this scenario, the user owns a parcel which is suffering from an erosion problem and is trying to figure out what can be done to ameliorate it (other motivations could be other forms of altering ecological conditions, earning credits, offsetting ecological performance losses elsewhere and the like). After entering in identifying information about the user's parcel, the Area of Interest, the system retrieves information related to the currently known ecosystem services available at the parcel's location. These currently known ecosystem services are typically available from a plurality of publically available information resources. The combination of the currently available ecosystem resources and the physical coordinates of the AOI contribute to assigning the AOI an EcoAdress, which in this case is [HUC 12, 50, 10, 0, 40], where “HUC 12” is the parcel level (for example as shown in FIG. 2) and where the “50 ” is the ecosystem service value for the specific parcel, where the second “10” is the rating of the hydrosphere, the “0” is the management factor (on a scale of 0-5, where 5 is the best), and “40” is the cost factor (on a scale of 0-50, where 50 is the most expensive). It should be noted that these rating numbers could vary, depending on the relative weights of these factors, which are a function of the value that the user and/or the system places on them. For example, in this scenario the cost factor is ten times more important than the management factor, but in some scenarios it could be more or less, or even the management factor is weighted heavier than the cost factor.

Once an EcoAddress has been assigned to the user's AOI, an analysis is performed by the system for parcels with similar EcoAddresses. In an embodiment of the invention, the analysis expands, proceeding through more focused HUC units to broader HUC units, until a sufficient number (and/or sufficient quality) of similar EcoAddresses is identified, in this scenario, 4 have been identified. In an embodiment of the invention, the analysis stops when similar EcoAddresses with high ecosystem services values and/or high ratings for the management factor are identified (where goal or optimum ecosystem services values and/or where high management factors are defined for and/or by the user). In an embodiment of the invention, an optimum condition is chosen, for example the highest scoring EcoAddress is selected as being the optimum condition. Optionally, the optimum condition is not found in the analysis and is a theoretical optimum. In an embodiment of the invention, EcoAddresses which have an ESPI over a certain % are presented to the user, where the ESPI is calculated using their calculated ecosystem services value and the defined optimum.

The EcoAddresses which satisfy the user's parameters for high ecosystem values and/or high management factor scores are presented to the user in a list, where the management practices that have been implemented in these high scoring EcoAddresses are presented to the user. For example, the highest scoring parcel may have scored high because of the use of French drains and/or the planting of a particular type of vegetation. The second highest scoring parcel may have used a different type of vegetation which wasn't as effective at preventing erosion, as an example of why the ecosystem service value and/or the management score was lower. The user can choose to implement none, some or all of the management practices used on the similar EcoAddresses, making the decision on such factors as effectiveness, cost, aesthetics, and the like (in an embodiment of the invention, this same methodology would provide the score and therefore the valuation for use with the ESIM).

In an embodiment of the invention, once at least one change in management or condition of the AOI is made, the process can be run again, where different, similar EcoAddresses might be identified by the system because the AOI now has a different, hopefully enhanced, current ecosystem services score.

What is claimed is:

1. A method of calculating an ecosystem services index score, comprising:
receiving area of interest information from a user of an ecosystem services index calculating system;
assigning an ecoaddress to the area of interest by a processor of the system;
retrieving ecosystem services information about the area of interest from at least one database;
retrieving ecosystem services information about the area of interest on at least one scale size larger or smaller than the area of interest from at least one database; and,
deriving a multi-scale ecosystem services index score blending the retrieved ecosystem services information about the area of interest.

2. A method according to claim 1, where ecosystem services information includes at least one of soil metrics, geology, terrain, water metrics, air metrics, nature of land usage, wildlife, human demographics, financial, geography, manmade objects and consumables, forest, grasslands, agriculture, farming, wildlife, natural resources, carbon generation, water usage, weather, and energy consumption.

3. A method according to claim 1, where scale is represented by at least one of national, local or regional scale, a scale defined by geopositional accuracy, a scale as a function of the resolution of the data set or Hydraulic Unit Code.

4. A method according to claim 1, where the ecosystem services index score is derived based on a zoom level of the user on a digital map.

5. A method according to claim 4, where the score is recalculated as the user changes the zoom level on the map.

6. A method according to claim 1, where the score is automatically recalculated as the user manually shifts area of interest.

7. A method according to claim 1, where at least one of the receiving, assigning, retrieving and deriving is performed at a remote location relative to the user.

8. A method according to claim 1, further comprising comparing the ecosystem service index score of the area of interest with an ecosystems service index score of a second area.

9. A method according to claim 8, where the second area is an area that is similar in some aspect to the area of interest.

10. A method according to claim 8, further comprising searching at least one database for additional areas similar in some aspect to the area of interest but with a higher ecosystem service index score.

11. A method according to claim 10, further comprising presenting to the user a list comprising at least one of the additional areas and the management practices associated with the at least one additional area.

12. A method according to claim 11, further comprising creating a challenge to at least one user to encourage the adoption of at least one presented management practice.

13. A method according to claim 12, further comprising sharing the challenge on at least one social media platform to involve additional users.

14. A method according to claim 12, further comprising awarding credits to the at least one user for adopting at least one presented management practice.

15. A method of providing an ecosystem services index marketplace, comprising:
creating a universal ecosystem services index capable of placing a value on ecosystem services;
assigning an ecosystem services index score to at least one service or holding; and,
facilitating the transfer of the at least one service or holding,
where the ecosystem services index score is the measure of value for conducting the transfer of the at least one service or holding.

16. A method according to claim 15, where a holding is at least one of a service, property, item and product.

17. A method according to claim 15, where facilitating is through at least one of auction, selling, buying, trading, and exchanging.

18. A system for calculating an ecosystem services index score, comprising:
at least one user interface device configured to receive input from a user and display system output;
at least one database with ecosystem services information stored thereon;
at least one processor configured to derive at least one ecosystem services index score based on received user input from the at least one user interface device and ecosystem services information retrieved from the at least one database.

19. A system according to claim 18, where at least one of the at least one database and at least one processor are located remotely from the user.

20. A system according to claim 18, where the user interface device is at least one of a computer, a phone, a tablet and terminal.

21. A system according to claim 18, where the at least one database is a database accessible via a global communications network.
